(19) United States
(12) Patent Application Publication
(10) Pub. No.: US 2007/0292008 A1
(43) Pub. Date: Dec. 20, 2007

(54) Image comparing apparatus using feature values of partial images

(75) Inventors: Manabu Yumoto, Nara-Shi (JP); Manabu Onozaki, Nara-Shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/806,512

(22) Filed: May 31, 2007

(30) Foreign Application Priority Data
Jun. 1, 2006 (JP) 2006-153826

(51) Int. Cl. G06K 9/00

(52) U.S. Cl. 382/124

(57) ABSTRACT

An element determining unit detects an element not to be used for comparison in an image. Comparison is performed using the image not including the detected element. Untargeted element determination is performed to calculate a feature value according to a pattern of the partial image corresponding to each of the partial images in the image. As the element not to be used, a region indicated by a combination of the partial images having predetermined calculated feature values is detected.

This nonprovisional application is based on Japanese Patent Application No. 2006-153826 filed with the Japan Patent Office on Jun. 1, 2006 the entire contents of which are hereby incorporated by reference.

### BACKGROUND OF THE INVENTION

1. Field of the Invention

The present invention relates to an image comparing apparatus, and particularly to an image comparing apparatus detecting a comparison-untargeted element in an image to be compared.

2. Description of the Background Art

There are increasing tendencies to employ a technology of authenticating personal identification, e.g., for giving permission of use of devices to users. In many cases, the personal authentication is performed using bodily features of individuals and, for example, fingerprints are used in view of easy collection. For the authentication using the fingerprint, image comparison is performed using a fingerprint image that is read from a user's finger placed on a fingerprint read surface of a fingerprint sensor.

When the fingerprint read surface is stained in the fingerprint authenticating operation, the fingerprint image contains noise components due to such smear so that the correct image comparison cannot be performed. Japanese Patent Laying-Open No. 62-197878 has disclosed a method for overcoming the above disadvantage.

In this publication, a fingerprint comparing apparatus captures an image of a finger table or plate before a finger is placed thereon, detects a contrast of a whole image thus captured and determines whether the finger table is stained or not, based on whether a detected contrast value exceeds a predetermined value or not. When the apparatus detects that the contrast value exceeds the predetermined value, it issues an alarm. When the alarm is issued, a user must clean the finger table and then must place the finger thereon again for image capturing. This results in low operability.

According to the above publication, the user is required to remove any smear that is detected on the finger table prior to the fingerprint comparison, resulting in inconvenience. Further, the processing is configured to detect any smear based on image information about the whole finger table. Therefore, even when the position and/or the size of the smear do not interfere with actual fingerprint comparison, the user is required to clean the table and to perform the operation of capturing the fingerprint image again. Therefore, the comparison processing takes a long time, and imposes inconvenience on the users.

### SUMMARY OF THE INVENTION

Accordingly, an object of the invention is to provide an image comparing apparatus that can efficiently perform image comparison.

For achieving the above object, an image comparing apparatus according to an aspect of the invention includes an element detecting unit detecting an element not to be used for comparison in an image; a comparison processing unit performing comparison using the image not including the element detected by the element detecting unit; and a feature value detecting unit detecting and providing a feature value according to a pattern of a partial image corresponding to each of the partial images in the image. The element detecting unit detects, as the above element, a region indicated by a combination of the partial images having predetermined feature values provided from the feature value detecting unit.

Preferably, the image is an image of a fingerprint. The feature values provided from the feature value detecting unit is classified as a value indicating that the pattern of the partial image extends in a vertical direction of the fingerprint, a value indicating that the pattern of the partial image extends in a horizontal direction of the fingerprint or a value indicating otherwise.

Preferably, the image is an image of a fingerprint. The feature value provided from the feature value detecting unit is classified as a value indicating that the pattern of the partial image extends in an obliquely rightward direction of the fingerprint, a value indicating that the pattern of the partial image extends in an obliquely leftward direction of the fingerprint or a value indicating otherwise.

Preferably, the predetermined feature value is one of the other values.

Preferably, the combination is a combination of the plurality of partial images having the feature values classified as the otherwise values and neighboring to each other in a predetermined direction.

Preferably, the comparison processing unit includes a position searching unit searching first and second images to be compared, and searching a position of a region indicating a maximum score of matching with a partial region of the first image in the partial regions not including a region of the element detected by the element detecting unit in the second image, a similarity score calculating unit calculating and providing a score of similarity between the first and second images based on a positional relationship quantity indicating a relationship between a reference position for measuring the position of the region in the first image and a position of a maximum matching score searched by the position searching unit, and a determining unit determining, based on the provided similarity score, whether the first and second images match each other or not.

Preferably, the position searching unit searches the maximum matching score position in each of the partial images in the partial regions of the second image not including the region of the element detected by the element detecting unit, and the similarity score calculating unit provides, as the similarity score, the number of the partial images exhibiting such a relationship that a quantity of the positional relationship between the maximum matching score position searched by the position searching unit and the reference position in the partial image of the second image is smaller than a predetermined quantity.

Preferably, the positional relationship quantity indicates a direction and a distance of the maximum matching score position with respect to the reference position.

Preferably, a sum of the maximum matching scores obtained from the partial images having the positional relationship quantity smaller than the predetermined quantity is provided as the similarity score.

Preferably, the image comparing apparatus further includes an image input unit for inputting the image, and a registered image storage storing images of a plurality of the preregistered partial images. The partial images of the first image are read from the registered image storage, and the other image is input by the image input unit.

Preferably, the image input unit has a read surface bearing a target for reading an image of the target placed on the read surface.

According to another aspect of the invention, an image comparing method using a computer for comparing an image includes the steps of: detecting an element not to be used for comparison in the image; performing comparison using the image not including the element detected by the step of the element detection; and detecting and providing a feature value according to a pattern of a partial image corresponding to each of the partial images in the image. The step of detecting the element detects, as the element, a region indicated by a combination of the partial images having predetermined feature values provided from the step of detecting the feature value.

According to still another aspect, the invention provides an image comparison program for causing a computer to execute the above image comparison method.

According to yet another aspect, the invention provides a computer-readable record medium bearing an image comparison program for causing a computer to execute the above image comparison method.

According to the invention, the feature value according to the pattern of each of the plurality of partial images is detected corresponding to each partial image in the comparison target image, and thereby the element that is the region indicated by the combination of the partial images having the predetermined feature values. The comparison processing is performed using the images from which the detected elements are removed.

Since the elements to be untargeted for comparison are detected and the comparison is performed on the images not including the detected elements, the image comparison can be continued without an interruption even when the image contains the element that cannot be compared due to noise components such as smear. Accordingly, it is possible to increase the number of images compared per time, and to achieve high comparison processing efficiency.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an image comparing apparatus of an embodiment of the invention.

FIG. 2 illustrates a structure of a computer provided with the image comparing apparatus according to the embodiment of the invention.

FIG. 3 shows a structure of a fingerprint sensor according to the embodiment of the invention.

FIG. 4 is a flowchart of comparison processing according to the embodiment of the invention.

FIG. 5 illustrates pixels of an image used for calculating three kinds of feature values according to the embodiment of the invention.

FIG. 6 is a flowchart for calculating the three kinds of feature values according to the embodiment of the invention.

FIG. 7 is a flowchart of processing of obtaining a maximum number of continuous black pixels in a horizontal direction according to the embodiment of the invention.

FIG. 8 is a flowchart of processing of obtaining a maximum number of continuous black pixels in a vertical direction according to the embodiment of the invention.

FIGS. 9A-9F schematically show processing of calculating an image feature value according to the embodiment of the invention.

FIGS. 10A-10C are a flowchart illustrating calculation of a feature value of a partial image according to the embodiment of the invention as well as diagrams illustrating the partial image to be referred to.

FIG. 11 is a flowchart of processing of obtaining an increase caused by shifting a partial image leftward and rightward according to the embodiment of the invention.

FIG. 12 is a flowchart of processing of obtaining an increase caused by shifting a partial image upward and downward according to the embodiment of the invention.

FIG. 13 is a flowchart of processing of obtaining a difference in pixel value between an original partial image and partial images produced by shifting the original image upward and downward as well as leftward and rightward.

FIGS. 14A-14F schematically show processing of calculating image feature values according to the embodiment of the invention.

FIGS. 15A-15C are a flowchart illustrating calculation of a feature value of a partial image according to the embodiment of the invention as well as diagrams illustrating the partial image to be referred to.

FIG. 16 is a flowchart of processing of obtaining an increase caused by shifting a partial image obliquely rightward according to the embodiment of the invention.

FIG. 17 is a flowchart of processing of obtaining an increase caused by shifting a partial image obliquely leftward according to the embodiment of the invention.

FIG. 18 is a flowchart of processing of obtaining a difference in pixel value between an original partial image and partial images produced by shifting the original image obliquely leftward and obliquely rightward according to the embodiment of the invention.

FIG. 19 is a flowchart illustrating calculation of a feature value of a partial image according to the embodiment of the invention.

FIGS. 20A-20C illustrate specific examples of comparison processing according to the embodiment of the invention.

FIGS. 21A-21C illustrate specific examples of comparison processing according to the embodiment of the invention.

FIG. 22 is a flowchart of finding a maximum matching score position and similarity score calculation according to the embodiment of the invention.

FIGS. 23A-23F illustrate specific examples of comparison processing according to the embodiment of the invention.

FIG. 24 is a flowchart of processing of determining a comparison-untargeted element according to the embodiment of the invention.

FIGS. 25A-25F schematically show steps of comparison performed in view of comparison-untargeted elements according to the embodiment of the invention.

### DESCRIPTION OF THE PREFERRED EMBODIMENTS

Embodiments of the invention will now be described with reference to the drawings.

### First Embodiment

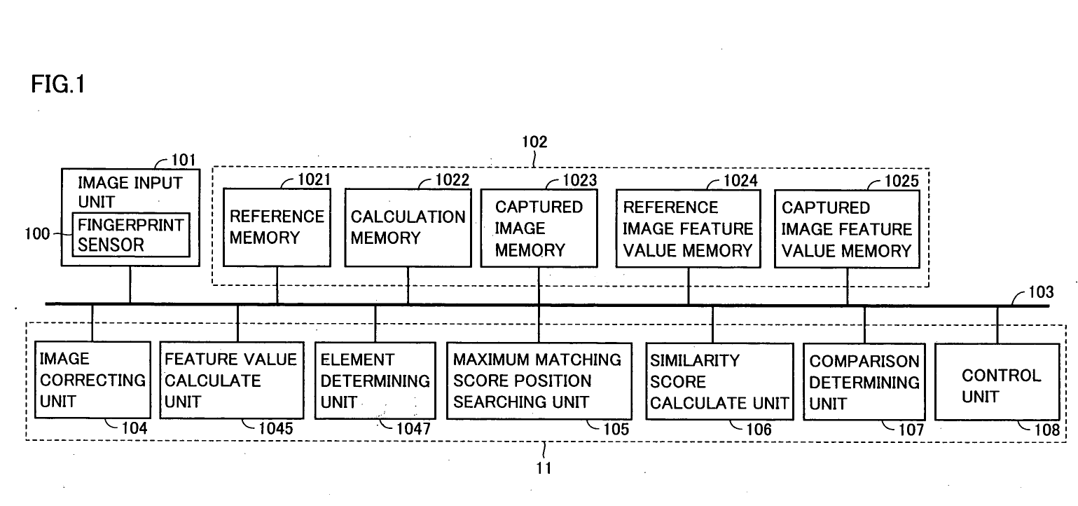

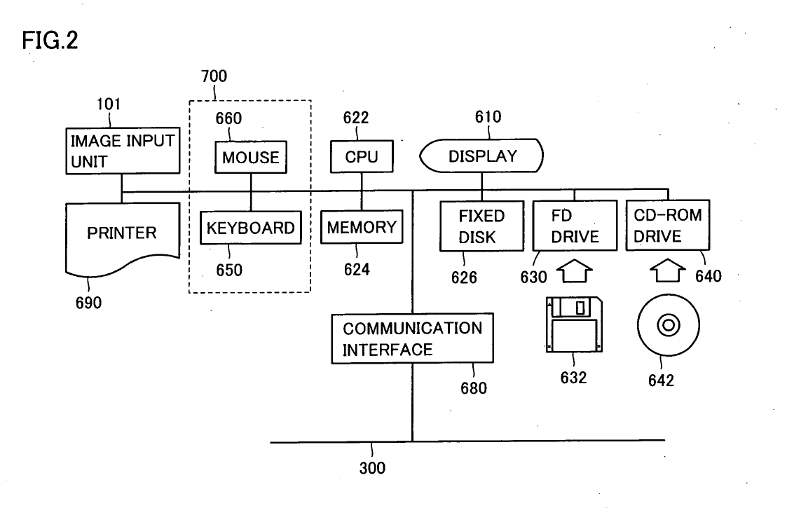

FIG. 1 is a block diagram of an image comparing apparatus 1 according to a first embodiment of the invention. FIG. 2 shows a structure of a computer that is provided with the image comparing apparatus according to each of the embodiments. Referring to FIG. 2, the computer includes an image input unit 101, a display 610 formed of a CRT (Cathode-Ray Tube) or a liquid crystal display, a CPU (Central Processing Unit) 622 for central management and control of the computer, a memory 624 including a ROM (Read Only Memory) or a RAM (Random Access Memory), a fixed disk 626, a flexible disk drive 630 for accessing an FD (Flexible Disk) 632 removably loaded thereinto, a CD-ROM drive 640 for accessing a CD-ROM (Compact Disk Read Only Memory) 642 that is removably loaded thereinto, a communication interface 680 for connecting the computer to a communications network 300, a printer 690 and an input unit 700 having a keyboard 650 and a mouse 660. These portions are connected via a bus for communications.

The computer may be provided with a magnetic tape drive for accessing a magnetic tape of a cassette type that is removably loaded thereinto.

Referring to FIG. 1, the image comparing apparatus includes image input unit 101, a memory 102 corresponding to memory 624 or fixed disk 626 in FIG. 2, a bus 103 and a comparison processing unit 11. Memory 102 includes a reference memory 1021 (i.e., memory for reference), a calculation memory 1022, a captured image memory 1023, a reference image feature value memory 1024 and a captured image feature value memory 1025. Comparison processing unit 11 includes an image correcting unit 104, a partial image feature value calculator (which will be referred to as a “feature value calculator” hereinafter) 1045, a comparison-untargeted image element determining unit (which will be referred to as an “element determining unit” hereinafter) 1047, a maximum matching score position searching unit 105, a similarity score calculate unit 106 which is employed for calculating a similarity score based on a movement vector (and will be referred to as “similarity score calculator” hereinafter), a comparison determining unit 107 and a control unit 108. The respective units of comparison processing unit 11 achieve their functions by executing corresponding programs.

Image input unit 101 includes a fingerprint sensor 100, and provides fingerprint image data corresponding to the fingerprint read by fingerprint sensor 100. Fingerprint sensor 100 may be of any one of optical, pressure and capacitance types.

Memory 102 stores image data and various calculation results. Reference memory 1021 stores a plurality of partial images of template fingerprint images (i.e., fingerprint images for templates). Calculation memory 1022 stores various calculation results and the like. Captured image memory 1023 stores fingerprint image data provided from image input unit 101. Reference image feature value memory 1024 and captured image feature value memory 1025 store results of calculation performed by feature value calculate unit 1045 to be described later. Bus 103 is used for transferring control signals and data signals between various units.

Image correcting unit 104 corrects a density in the fingerprint image data provided from image input unit 101.

Feature value calculate unit 1045 performs the calculation for each of the images in a plurality of partial regions set in the image, and obtains a value corresponding to a pattern represented by the partial image. Feature value calculate unit 1045 provides, as a partial image feature value, the result of this calculation corresponding to the reference memory to reference image feature value memory 1024, and provides the result of the calculation corresponding to the captured image memory to captured image feature value memory 1025.

In the operation of determining the comparison-untargeted image element, element determining unit 1047 refers to captured image feature value memory 1025, and performs the determinations about the comparison-untargeted image element according to the combination of the feature values of partial images in specific portions of the image.

Maximum matching score position searching unit 105 is similar to a so-called template matching portion. More specifically, it restricts the comparison-targeted partial image with reference to determination information calculated by element determining unit 1047. Further, maximum matching score position searching unit 105 reduces a search range according to the partial image feature values calculated by feature value calculate unit 1045. Then, maximum matching score position searching unit 105 uses a plurality of partial regions in one of the fingerprint images as the template, and finds a position achieving the highest score of matching between this template and the other fingerprint image.

Similarity score calculate unit 106 calculates the similarity score based on a movement vector to be described later, using the result information of maximum matching score position searching unit 105 stored in memory 102. Comparison determining unit 107 determines the matching or mismatching based on the similarity score calculated by similarity score calculate unit 106. Control unit 108 controls the processing by the various units in comparison processing unit 11.

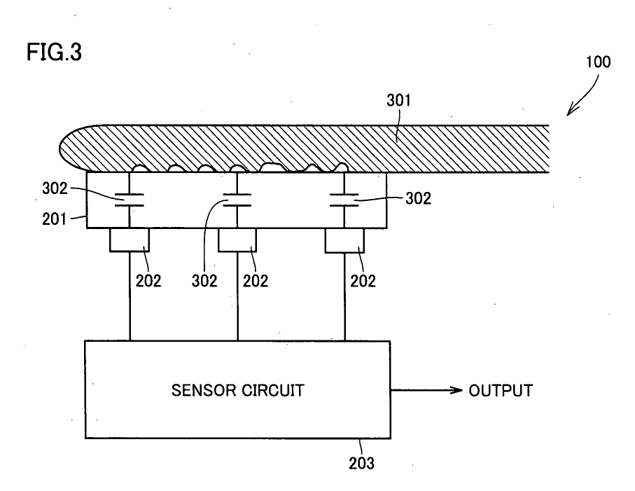

FIG. 3 shows, by way of example, a structure of fingerprint sensor 100 of the capacitance type. As shown therein, fingerprint sensor 100 includes a sensor circuit 203, a fingerprint read surface 201 and a plurality of electrodes 202. As shown in FIG. 3, when a user having a fingerprint to be compared places his/her finger 301 on fingerprint read surface 201 of fingerprint sensor 100, a capacitor 302 is formed between each sensor electrode 202 and finger 301. In this state, since the fingerprint of finger 301 placed on read surface 201 has irregularities, finger 301 is spaced from respective electrodes 202 by different distances so that respective capacitors 302 formed therebetween have different capacitances. Sensor circuit 203 senses the differences in capacitance between the capacitors 302 based on the output voltage levels of electrodes 202, and performs conversion and amplification to provide the voltage signal indicating such differences. In this manner, the voltage signal provided from sensor circuit 203 corresponds to the image that represents the state of irregularities of the fingerprint placed on fingerprint read surface 201.

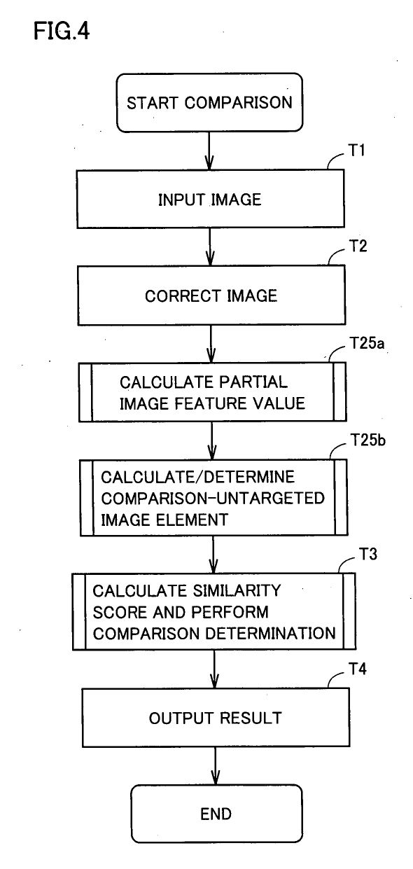

For comparison between the two fingerprint images, image comparing apparatus 1 shown in FIG. 1 performs the comparison between images (image data) “A” and “B” that correspond to two fingerprint images obtained from image input unit 101, respectively, and steps for such comparison will now be described according to a flowchart of FIG. 4.

First, control unit 108 transmits a signal for starting the image input to image input unit 101, and then waits for reception of an image input end signal. Image input unit 101 performs the input of image “A” to be compared, and stores input image “A” via bus 103 at a predetermined address in memory 102 (step T1). In this embodiment, input image “A” is stored at the predetermined address in reference memory 1021. After the input of image “A”, image input unit 101 transmits the image input end signal to control unit 108.

After control unit 108 receives the image input end signal, it transmits the image input start signal to image input unit 101 again, and then waits for reception of the image input end signal. Image input unit 101 performs the input of an image “B” to be compared, and stores input image “B” via bus 103 at a predetermined address in memory 102 (step T1). In this embodiment, image “B” is stored at a predetermined address in captured image memory 1023. After the input of image “B”, image input unit 101 transmits the image input end signal to control unit 108.

Then, control unit 108 transmits an image correction start signal to image correcting unit 104, and then waits for reception of an image correction end signal. In many cases, density values of respective pixels and a whole density distribution of input images vary depending on characteristics of image input unit 101, a degree of dryness of a skin and a pressure of a placed finger, and therefore image qualities of the input images are not uniform. Accordingly, it is not appropriate to use the image data for the comparison as it is. Image correcting unit 104 corrects the image quality of the input image to suppress variations in conditions at the time of image input (step T2). More specifically, processing such as flattening of histogram (“Computer GAZOU SHORI NYUMON (Introduction to computer image processing)”, SOKEN SHUPPAN, p. 98) or image thresholding or binarization (“Computer GAZOU SHORI NYUMON (Introduction to computer image processing)”, SOKEN SHUPPAN, pp. 66-69) is performed on the whole image corresponding to the input image data or each of small divided regions of the image, and more specifically, is performed on images “A” and “B” stored in memory 102, i.e., in reference memory 1021 and captured image memory 1023.

After image correcting unit 104 completes the image correction of images “A” and “B”, it transmits the image correction end signal to control unit 108.

Thereafter, feature value calculate unit 1045 calculates the feature values of the partial images of the image subjected to the image correction by image correcting unit 104 (step T25a). Thereafter, element determining unit 1047 performs the determination about the comparison-untargeted image elements (step T25b). Then, similarity score calculate unit 106 performs the calculation of the similarity score, and comparison determining unit 107 performs comparison determination (step T3). Printer 690 or display 610 outputs the result of such comparison determination (step T4). Processing in steps T25a, T25b and T3 will be described later in greater detail.

(Calculation of Partial Image Feature Value)

Then, description will be given on steps of calculating the feature value of the partial image in step T25a.

<Three Kinds of Feature Values>

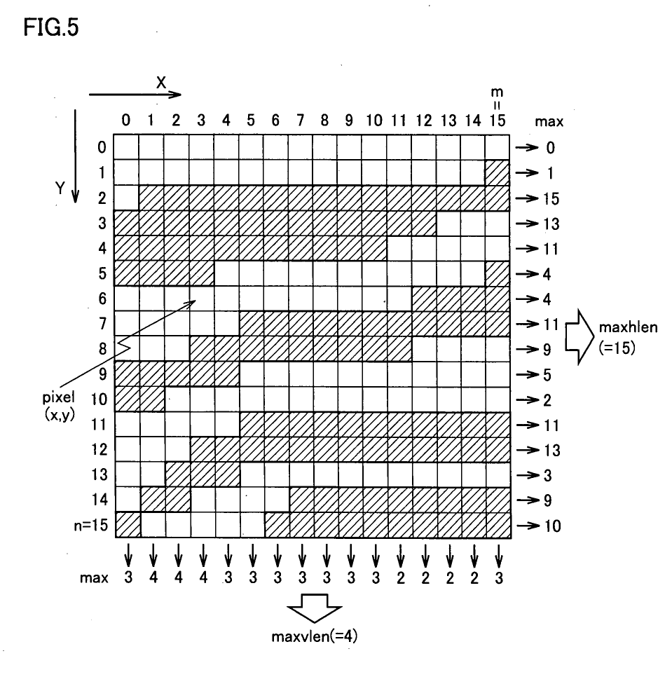

Description will now be given on the case where three kinds of feature values are employed. FIG. 5 illustrates details such as maximum values of the numbers of pixels in the horizontal and vertical directions of each of the comparison target images “A” and “B”. It is assumed that each of images “A” and “B” as well as the partial images has a rectangular form corresponding to a two-dimensional coordinate space defined by X- and Y-axes perpendicular to each other. Each of the partial images in, FIG. 5 is formed of 16 by 16 pixels in the horizontal and vertical directions, i.e., X- and Y-axis direction.

The partial image feature value calculation in the first embodiment is performed to obtain, as the partial image feature value, a value corresponding to the pattern of the calculation target partial image. More specifically, processing is performed to detect maximum numbers “maxhlen” and “maxvlen” of black pixels that continue to each other in the horizontal and vertical directions, respectively. Maximum continuous black pixel number “maxhlen” in the horizontal direction indicates a magnitude or degree of tendency that the pattern extends in the horizontal direction (i.e., it forms a lateral stripe), and maximum continuous black pixel number “maxvlen” in the vertical direction indicates a magnitude or degree of tendency that the pattern extends in the vertical direction (i.e., it forms a longitudinal stripe). These values “maxhlen” and “maxvlen” are compared with each other. When it is determined from the comparison that this pixel number in the horizontal direction is larger than the others, “H” indicating the horizontal direction (lateral stripe) is output. When the determined pixel number in the vertical direction is larger than the others, “V” indicating the vertical direction (longitudinal stripe) is output. Otherwise, “X” is output.

Referring to FIG. 5, maximum continuous black pixel number “maxhlen” indicates the maximum number among the sixteen detected numbers of the continuing black pixels (hatched in FIG. 5) in the respective rows, i.e., sixteen rows (“n”=0-15). The detected number of the continuous black pixels in each row indicates the maximum number among the numbers of the detected black pixels located continuously to each other in the row. Maximum continuous black pixel number “maxvlen” indicates the maximum number among the sixteen detected numbers of the continuing black pixels (hatched in FIG. 5) in the respective columns, i.e., sixteen columns (“m”=0-15). The detected number of the continuous black pixels in each column indicates the maximum number among the numbers of the detected black pixels located continuously to each other in the column.

However, even when the result of the determination is “H” or “V”, it may be determined that neither of maximum continuous black pixel number “maxhlen” and “maxvlen” is smaller than a corresponding lower limit “hlen0” or “vlen0” that is predetermined for the corresponding direction. In this case, “X” is output. These conditions can be expressed as follows. When (maxhlen>maxvlen and maxhlen≧hlen0) is satisfied, “H” is output. When (maxvlen>maxhlen and maxvlen≧vlen0) is satisfied, “V” is output. Otherwise, “X” is output.

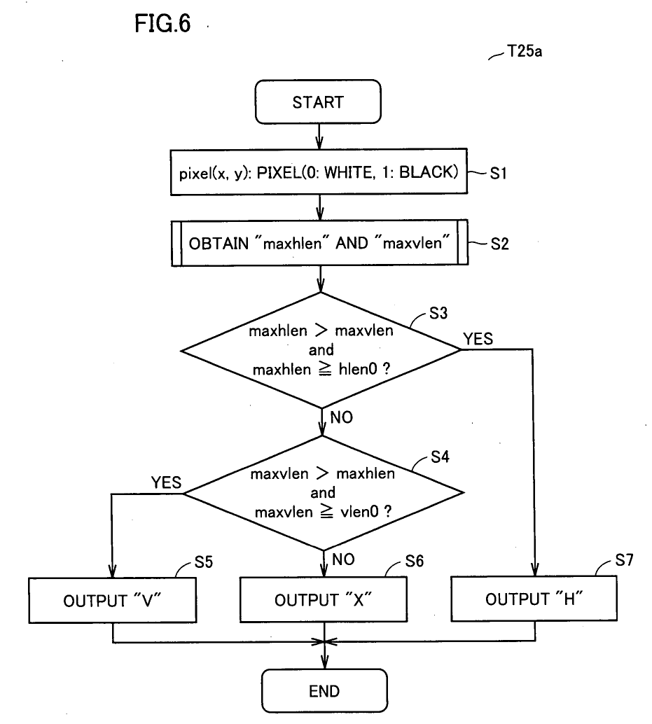

FIG. 6 is a flowchart of the processing of calculating the partial image feature value according to the first embodiment of the invention. The processing in this flowchart is related for partial images “Ri” that are images in partial regions of N in number of the reference image, i.e., the calculation target stored in reference memory 1021. Reference image feature value memory 1024 stores the resultant values of this calculation in a fashion correlated to respective partial images “Ri”. Likewise, the processing is repeated for partial images “Ri” of n in number in captured image “B” stored in captured image memory 1023, and the resultant values of this calculation are stored in captured image feature value memory 1025 in a fashion correlated to respective partial images “Ri”.

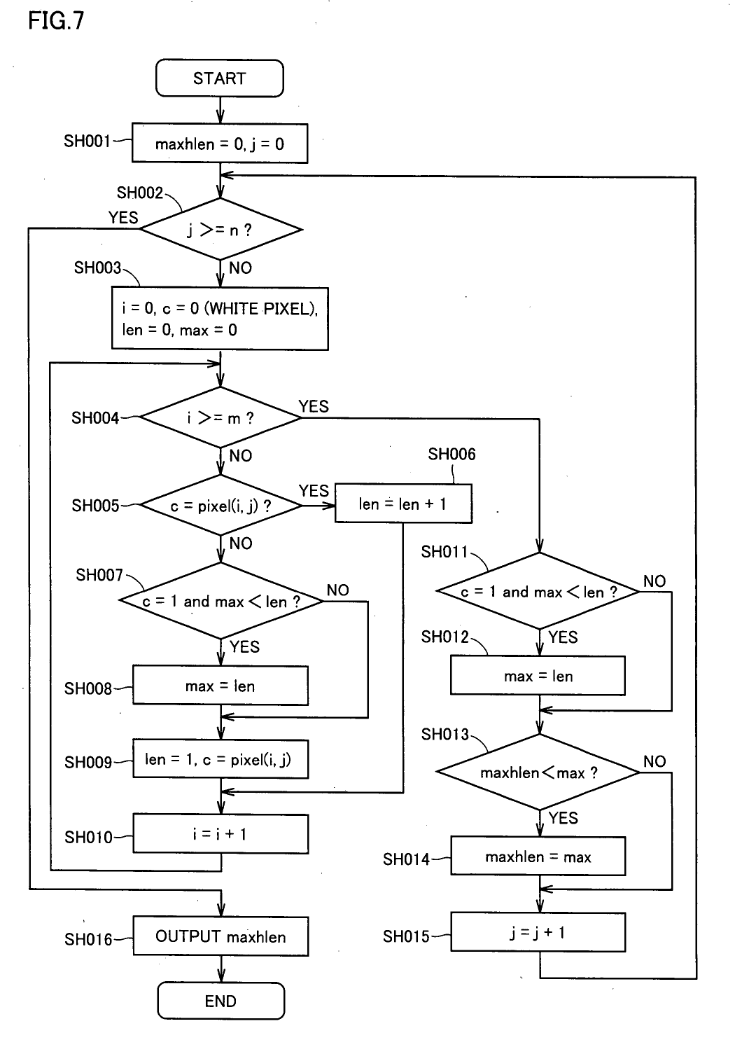

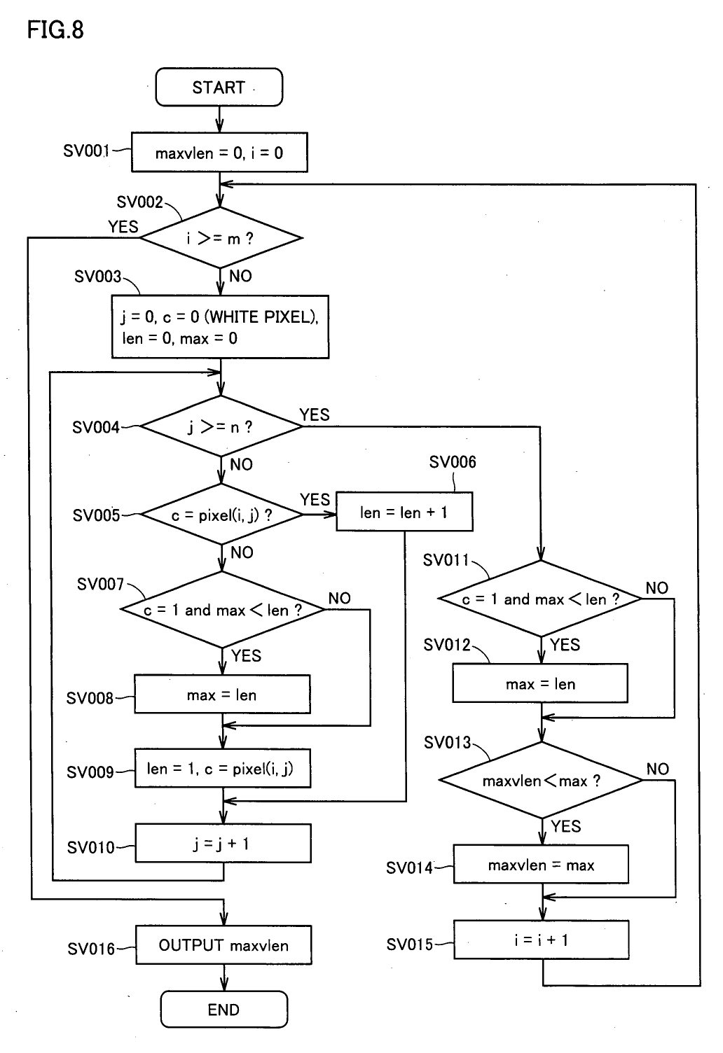

First, control unit 108 transmits a calculation start signal for the partial image feature values to feature value calculate unit 1045, and then waits for reception of a calculation end signal for the partial image feature values. Feature value calculate unit 1045 reads partial images “Ri” of the calculation target images from reference memory 1021 and captured image memory 1023, and temporarily stores them in calculation memory 1022 (step S1). Feature value calculate unit 1045 reads stored partial image “Ri”, and obtains maximum continuous black pixel numbers “maxhlen” and “maxvlen” in the horizontal and vertical directions (step S2). Processing of obtaining maximum continuous black pixel numbers “maxhlen” and “maxvlen” in the horizontal and vertical directions will now be described with reference to FIGS. 7 and 8.

FIG. 7 is a flowchart of processing (step S2) of obtaining maximum continuous black pixel numbers “maxhlen” and “maxvlen” in the horizontal and vertical directions according to the first embodiment of the invention. Feature value calculate unit 1045 reads partial image “Ri” from calculation memory 1022, and maximum continuous black pixel number “maxhlen” in the horizontal direction and a pixel count “j” in the vertical direction are initialized (i.e., “maxhlen”=0 and “j”=0) in step SH001.

Then, the value of pixel count “j” in the vertical direction is compared with the value of a variable “n” indicating the maximum pixel number in the vertical direction (step SH002). When (J=>n) is satisfied, step SH016 is executed. Otherwise, step SH003 is executed. In the first embodiment, “n” is equal to 16, and “j” is equal to 0 at the start of the processing so that the process proceeds to step SH003.

In step SH003, processing is performed to initialize a pixel count “i” in the horizontal direction, last pixel value “c”, current continuous pixel value “len” and maximum continuous black pixel number “max” in the current row to attain (i=0, c=0, len=0 and max=0) in step SH003. Then, pixel count “i” in the horizontal direction is compared with maximum pixel number “m” in the horizontal direction (step SH004). When (i≧m) is satisfied, processing in step SH011 is executed, and otherwise next step SH005 is executed. In the first embodiment, “m” is equal to 16, and “i” is equal to 0 at the start of the processing so that the process proceeds to step SH005.

In step SH005, last pixel value “c” is compared with a current comparison target, i.e., a pixel value “pixel (i, j)” at coordinates (i, j). In the first embodiment, “c” is already initialized to 0 (white pixel), and “pixel (0, 0)” is 0 (white pixel) with reference to FIG. 5. Therefore, it is determined that (c=pixel (0, 0)) is established (YES in step SH005), and the process proceeds to step SH006.

In step SH006, (len=len+1) is executed. In the first embodiment, since “len” is already initialized to 0, it becomes 1 when 1 is added thereto. Then, the process proceeds to step SH010.

In step SH010, the pixel count in the horizontal direction is incremented by one (i.e., i=i+1). Since “i” is already initialized to 0 (i=0), it becomes 1 when 1 is added thereto (i=1). Then, the process returns to step SH004. Thereafter, all the pixels “pixel (i, 0)” in the 0th row are white and take values of 0 as illustrated in FIG. 5. Therefore, steps SH004-SH010 are repeated until “i” becomes 15. When “i” becomes 16 after the processing in step SH010, “i” is 16, “c” is 0 and “len” is 15. Then, the process proceeds to step SH004. Since “m” is 16 and “i” is 16, the process further proceeds to step SH011.

In step SH011, when (c=1 and max<len) are satisfied, step SH012 is executed, and otherwise step SH013 is executed. At this point in time, “c” is 0, “len” is 15 and “max” is 0 so that the process proceeds to step SH013.

In step SH013, maximum continuous black pixel number “maxhlen” in the horizontal direction that are already obtained from the last and preceding rows are compared with maximum continuous black pixel number “max” in the current row. When (maxhlen<max) is attained, processing is executed in step SH014, and otherwise processing in step SH015 is executed. Since “maxhlen” and “max” are currently equal to 0, the process proceeds to step SH015.

In step SH015, (j=j+1) is executed, and thus pixel count “j” in the vertical direction is incremented by one. Since “j” is currently equal to 0, “j” becomes 1, and the process returns to step SH002.

Thereafter, the processing in steps SH002-SH015 are similarly repeated for “j” from 1 to 15. When “j” becomes 16 after the processing in step SH015, the processing in next step SH002 is performed to compare the value of pixel count “j” in the vertical direction with the value of maximum pixel number “n” in the vertical direction. When the result of this comparison is (j≧n), step SH016 is executed, and otherwise step SH003 is executed. Since “j” and “n” are currently 16, the process proceeds to step SH016.

In step SH016, “maxhlen” is output. According to the description already given and FIG. 5, “maxhlen”, i.e., maximum continuous black pixel number in the horizontal direction is 15 that is the maximum value in y=2 (2nd row), and “maxhlen” equal to 15 is output.

Description will now be given on a flowchart of the processing (step S2) of obtaining maximum continuous black pixel number “maxvlen” in the vertical direction. This processing is performed in the processing (Step T2a) of calculating the partial image feature value according to the first embodiment of the invention. Since it is apparent that the processing in steps SV001-SV016 in FIG. 8 is basically the same as that in the flowchart of FIG. 7 already described, the details of the processing in FIG. 8 can be easily understood from the description of the processing in FIG. 7. Therefore, description thereof is not repeated. As a result of execution of the processing according to the flowchart of FIG. 8, maximum continuous black pixel number “maxvlen” in the vertical direction takes the value of 4 which is the “max” value in the x-direction as illustrated in FIG. 5.

The subsequent processing performed with reference to “maxhlen” and “maxvlen” provided in the foregoing steps will now be described in connection with the processing in and after step S3 in FIG. 6.

In step S3, “maxhlen” is compared with “maxvlen” and predetermined lower limit “hlen0” of the maximum continuous black pixel number. When it is determined that the conditions of (maxhlen>maxvlen and maxhlen≧hlen0) are satisfied (YES in step S3), step S7 is executed. Otherwise (NO in step S3), step S4 is executed. Assuming that “maxhlen” is 14, “maxvlen” is 4 and lower limit “hlen0” is 2 in the current state, the above conditions are satisfied so that the process proceeds to step S7. In step S7, “H” is stored in reference image feature value memory 1024 or in the feature value storage region for partial image “Ri” corresponding to the original image in captured image feature value memory 1025, and the calculation end signal for the partial image feature value is transmitted to control unit 108.

Assuming that lower limit “hlen0” is 15, it is determined that the conditions are not satisfied in step S3, and the process proceeds to step S4. In step S4, it is determined whether the conditions of (maxvlen>maxhlen and maxvlen≧vlen0) are satisfied or not. When satisfied (YES in step S4), the processing in step S5 is executed. Otherwise, the processing in step S6 is executed.

Assuming that “maxhlen” is 15, “maxvlen” is 4 and “vlen0” is 5, the above conditions are not satisfied so that the process proceeds to step S6. In step S6, “X” is stored in reference image feature value memory 1024 or in the feature value storage region for partial image “Ri” corresponding to the original image in captured image feature value memory 1025, and transmits the calculation end signal for the partial image feature value to control unit 108.

Assuming that the output values exhibit the relationships of (maxhlen=4, maxvlen=10, hlen0=2 and vlen=12), the conditions in step S3 are not satisfied, and further the conditions in step S4 are not satisfied so that the personal computer in step S5 is executed. In step S5, “V” is stored in reference image feature value memory 1024 or in the feature value storage region for partial image “Ri” corresponding to the original image in captured image feature value memory 1025, and the calculation end signal for the partial image feature value is transmitted to control unit 108.

As described above, feature value calculate unit 1045 in the first embodiment of the invention extracts (i.e., specifies) the pixel rows and columns in the horizontal and vertical directions from partial image “Ri” (see FIG. 5) of the calculation target image, and performs the determination about the tendency of the pattern of the partial image, based on the numbers of the black pixels in each of the extracted pixel columns and rows. More specifically, it is determined whether the pattern tends to extend in the horizontal direction (i.e., to form a lateral stripe), in the vertical direction (i.e.; to form a longitudinal stripe) or in neither of the horizontal and vertical directions. A value (“H”, “V” or “X”) is output depending on the result of the determination. This output value indicates the feature value of partial image “Ri”. Although the feature value is obtained based on the number of the continuous black pixels, the feature value can likewise be obtained based on the number of continuous white pixels.

<Another Example of Three Kinds of Feature Values>

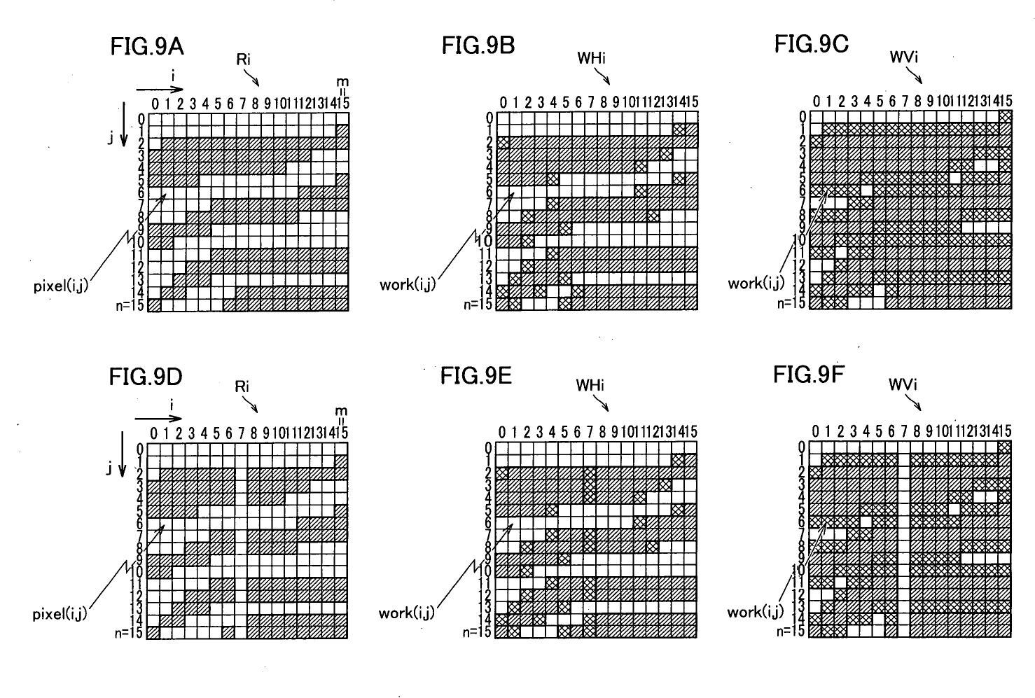

Another example of the three kinds of partial image feature values will be described. Calculation of the partial image feature values is schematically described below according to FIGS. 9A-9F. FIGS. 9A-9F illustrate partial images “Ri” of the image together as well as the total numbers of the black pixels (hatched portions in the figures) and white pixels (blank portions in the figures), and others. In these figures, partial image “Ri” includes 16 pixels in each of the horizontal and vertical directions, and thus is formed of a partial region of 16 by 16 pixels. In FIGS. 9A-9F, each partial image indicates a plane image corresponding to a two-dimensional coordinate space defined by “j” and “i” axes.

In this example, the processing is performed to obtain an increase (i.e., a quantity of increase) “hcnt” by which the black pixels are increased in number when calculation target partial image “Ri” is shifted leftward and rightward by one pixel as illustrated in FIG. 9B, and to obtain an increase “vcnt” by which the black pixels are increased in number when the calculation target partial image is shifted upward and downward as illustrated in FIG. 9C. A comparison is made between increases “hcnt” and “vcnt” thus obtained. When increase “hcnt” is larger than double increase “vcnt”, Value “H” indicating the horizontal or lateral direction is output. Otherwise, the value “V” indicating the vertical or longitudinal direction is output. FIGS. 9D-9F illustrate another example.

The increase of the black pixels caused by shifting the image leftward and rightward by one pixel as illustrated in FIGS. 9A-9C indicates the following. Assuming (i, j) represents the coordinates of each pixel in the original image of 16 by 16 pixels, the original image is shifted by one pixel in the i-axis direction to change the coordinates (i, j) of each pixel to (i+1, j). Also, the original image is shifted by minus one pixel in the i-axis direction to change the coordinates (i, j) of each pixel to (i−1, j). These two shifted images are overlaid on the original image to match the pixels in the same coordinates (i, j), and the difference in total number of the black pixels is obtained between the image (16×16 pixels) formed by the above overlaying and the original image. This difference is the foregoing increase of the black pixels caused by shifting the image leftward and rightward by one pixel difference.

The increase of the black pixels caused by shifting the image upward and downward by one pixel as illustrated in FIGS. 9D-9F indicates the following. Assuming (i, j) represents the coordinates of each pixel in the original image of 16 by 16 pixels, the original image is shifted by one pixel in the j-axis direction to change the coordinates (i, j) of each pixel to (i, j+1). Also, the original image is shifted by minus one pixel in the j-axis direction to change the coordinates (i, j) of each pixel to (i, j−1). These two shifted images are overlaid on the original image to match the pixels in the same coordinates (i, j), and the difference in total number of the black pixels is obtained between the image (16×16 pixels) formed by the above overlaying and the original image. This difference is the foregoing increase of the black pixels caused by shifting the image upward and downward by one pixel difference.

In the above case, when the black pixels of certain pixels overlap together, the black pixel is formed. When the white and block pixels overlap together, the black pixel is formed. When the while pixels overlap together, the white pixel is formed.

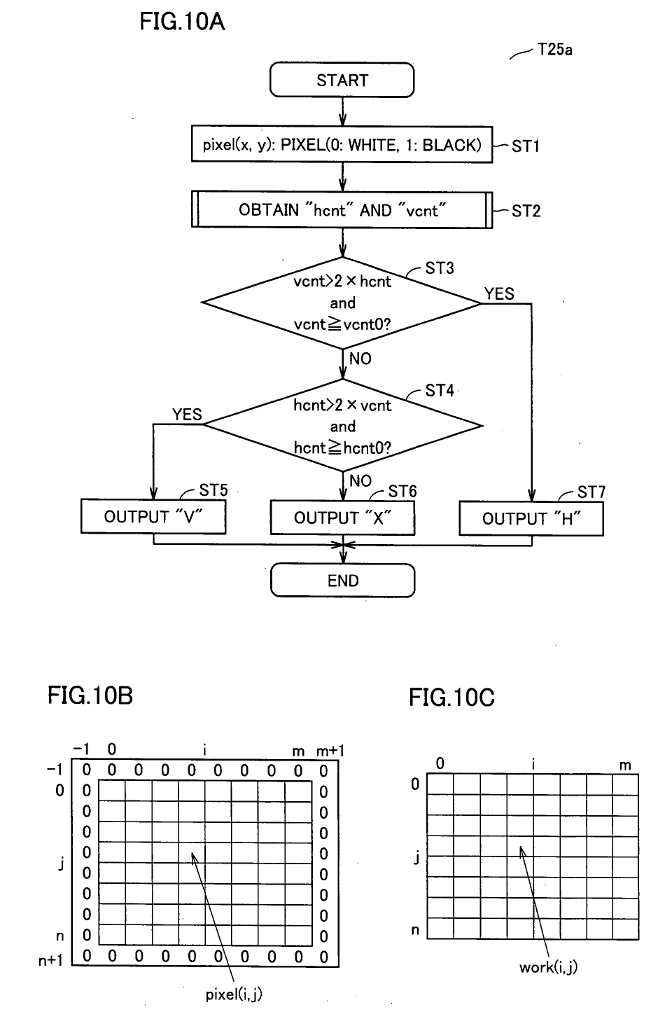

Details of the calculation of the partial image feature value will be described below according to the flowchart of FIG. 10A. The processing in this flowchart is repeated for partial images “Ri” of N in number of reference image “A” which is a calculation target and is stored in reference memory 1021. Reference image feature value memory 1024 stores result values of this calculation in a fashion correlated to respective partial images “Ri”. Likewise, the processing is repeated for partial images “Ri” of N in number of captured image “B” in captured image memory 1022. Captured image feature value memory 1025 stores result values of this calculation in a fashion correlated to respective partial images “Ri”.

First, control unit 108 transmits the calculation start signal for the partial image feature value to feature value calculate unit 1045, and then waits for reception of the calculation end signal for the partial image feature values.

Feature value calculate unit 1045 reads partial images “Ri” (see FIG. 9A) of the calculation target images from reference memory 1021 and captured image memory 1023, and temporarily stores them in calculation memory 1022 (step ST1). Partial image feature value calculate unit 1045 reads stored partial image “Ri”, obtains increase “hcnt” by shifting it leftward and rightward as illustrated in FIG. 9B and also obtains increase “vcnt” by shifting it upward and downward as illustrated in FIG. 9C (step ST2).

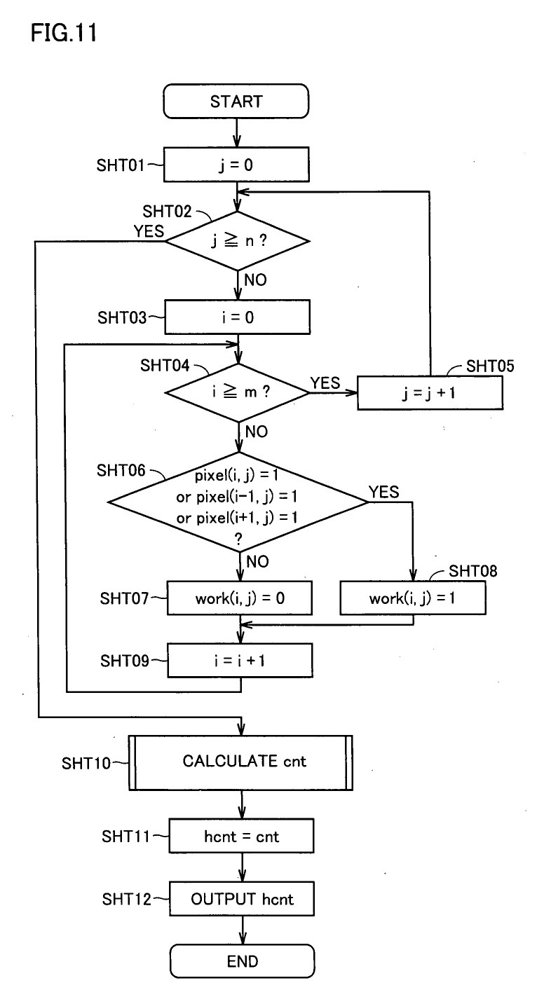

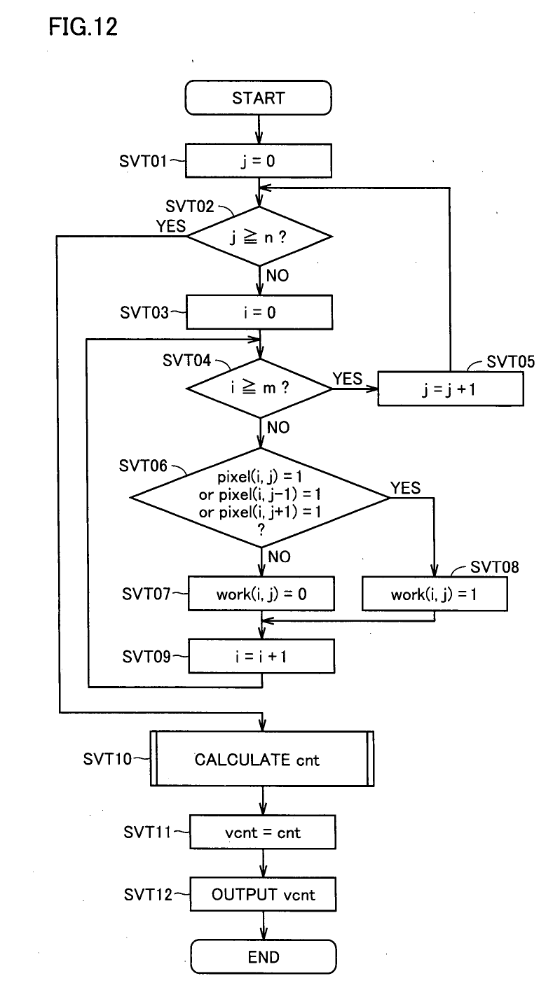

The processing for obtaining increases “hcnt” and “vcnt” will now be described with reference to FIGS. 11 and 12. FIG. 11 is a flowchart of processing (step ST2) of obtaining increase “hcnt”, and FIG. 12 is a flowchart of processing (step ST2) of obtaining increase “vcnt”.

Referring to FIG. 11, feature value calculate unit 1045 reads partial image “Ri” from calculation memory 1022, and initializes pixel count “j” in the vertical direction to zero (j=0) in step SHT01. Then, feature value calculate unit 1045 compares pixel count “j” in the vertical direction with maximum pixel number “n” in the vertical direction (step SHT02). When the comparison result is (j≧n), step SHT10 is executed. Otherwise, next step SHT03 is executed. Since “n” is equal to 16 and “j” is equal to 0 at the start of the processing, the process proceeds to step SHT03.

In step SHT03, feature value calculate unit 1045 initializes pixel count “i” in the horizontal direction to zero (i=0). Then, feature value calculate unit 1045 compares pixel count “i” in the horizontal direction with maximum pixel number “m” in the horizontal direction (step SHT04). When the comparison result is (i≧m), step SHT05 is executed. Otherwise, next step SHT06 is executed. Since “m” is equal to 16, and “j” is equal to 0 at the start of the processing, the process proceeds to step SHT06.

In step SHT06, partial image “Ri” is read, and it is determined whether the current comparison target, i.e., pixel value pixel (i, j) at coordinates (i, j) is 1 (black pixel) or not, whether pixel value pixel (i−1, j) at coordinates (i−1, j) shifted left by one from coordinates (i, j) is 1 or not, or whether pixel value pixel (i+1, j) at coordinates (i+1, j) shifted right by one from coordinates (i, j) is one or not. When (pixel (i, j)=1, pixel (i−1, j)=1 or pixel (i+1, j)=1) is attained, step SH08 is executed. Otherwise, step SHT07 is executed.

In a range defined by pixels shifted horizontally or vertically by one pixel from partial image “Ri”, i.e., in a range defined of pixels of Ri(−1, −m+1, −1), Ri(−1, −1−n+1), Ri(m+1, −1−n+1) and Ri(−1−m+1, n+1), it is assumed that the pixels take the values of (and are white) as illustrated in FIG. 10B. Referring to FIG. 9A, since the state of (pixel (0, 0)=0, pixel (−1, 0)=0 and pixel (1,0)=0), the process proceeds to step SHT07.

In step SHT07, pixel value work (i, j) at coordinates (i, j) of image “WHi” stored in calculation memory 1022 is set to 0. This image “WHi” is prepared by overlaying, on the original image, images prepared by shifting partial image “Ri” leftward and rightward by one pixel (see FIG. 10C). Thus, the state of (work (0, 0)=1) is attained. Then, the process proceeds to step SHT09.

In step SHT09, (i=i+1) is attained, and thus horizontal pixel count “i” is incremented by one. Since “i” was initialized to 0, “i” becomes one after addition of one. Then, the process returns to step SHT04. Thereafter, all the pixel values pixel (i, j) in the 0th row are 0 (white pixel) as illustrated in FIG. 9A so that steps SHT04-SHT09 will be repeated until (i=15) is attained. When the processing in step SFT09 is completed, “i” becomes equal to 16 (i=16). In this state, the process proceeds to step SHT04. Since the state of (m=16) and (i=16) is attained, the process proceeds to step SHT05.

In step SHT05, (j=j+1) is performed. Thus, vertical pixel count “j” is incremented by one. Since “j” was equal to 0, “j” becomes 1, and the process returns to step SHT02. Since the processing on a new row starts, the process proceeds to steps SHT03 and SHT04, similarly to the 0th row. Thereafter, processing in steps SHT04-SHT09 will be repeated until (pixel (i, j)=1) is attained, i.e., the pixel in the first row and fourteenth column (i=14 and j=1) is processed. After the processing in step SHT09, (i=14) is attained. Since the state of (m=16 and i=14) is attained, the process proceeds to step SHT06.

In step SHT06, (pixel (i+1, j)=1), i.e., (pixel (14+1, 1)=1) is attained so that the process proceeds to step SHT08.

In step SHT08, pixel value work (i, j) at coordinates (i, j) of image “WHi” stored in calculation memory 1022 is set to one. This image “WHi” is prepared by overlaying, on the original image, images prepared by shifting partial image “Ri” leftward and rightward by one pixel (see FIG. 9B. Thus, the state of (work (14, 1)=1) is attained.

The process proceeds to step SHT09. “i” becomes equal to 16 and the process proceeds to step SHT04. Since the state of (m=16 and i=16) is attained, the process proceeds to step SHT05, “j” becomes equal to 2 and the process proceeds to step SHT02. Thereafter, the processing in steps SHT02-SHT09 is repeated similarly for j=2−15. When “j” becomes equal to 16 after the processing in step SHT09, the processing is performed in step SHT02 to compare the value of vertical pixel count “J” with vertical maximum pixel number “n”. When the result of comparison indicates (j≧n), the processing in step SHT10 is executed. Otherwise, the processing in step SHT03 is executed. Since the state of (j=16 and n=16) is currently attained, the process proceeds to step SHT10. At this time, calculation memory 1022 has stored image “WHi” prepared by overlaying, on partial image “Ri” to be currently compared for comparison, images prepared by shifting partial image “Ri” leftward and rightward by one pixel.

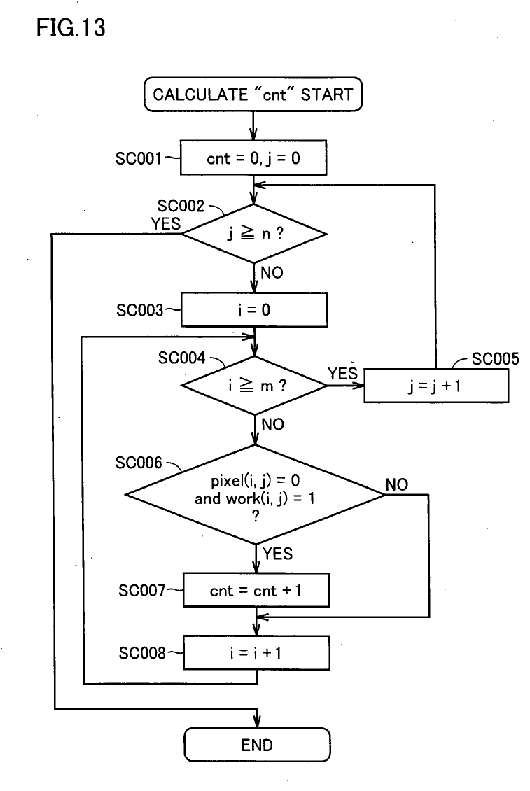

In step SHT10, calculation is performed to obtain a difference “cnt” between pixel value work (i, j) of image “WHi” stored in calculation memory 1022 and prepared by overlaying images shifted leftward and rightward by one pixel and pixel value pixel (i, j) of partial image “Ri” that is currently compared for comparison. The processing of calculating difference “cnt” between “work” and “pixel” will now be described with reference to FIG. 13.

FIG. 13 is a flowchart for calculating difference “cnt” in pixel value pixel (i, j) between partial image “Ri” that is currently compared for comparison and image “WHi” that is prepared by overlaying, on partial image “Ri”, the images prepared by shifting the image leftward and rightward, or upward and downward by one pixel. Feature value calculate unit 1045 reads, from calculation memory 1022, partial image “Ri” and images “WHi” prepared by one-pixel shifting and overlaying, and initializes difference count “cnt” and vertical pixel count “j” to attain (cnt=0 and j=0) (step SC001). Then, vertical pixel count “j” is compared with vertical maximum pixel number “n” (step SC002). When (j≧n) is attained, the process returns to steps in the flowchart of FIG. 11, and “cnt” is substituted into “hcnt” in step SHT11. Otherwise, the processing in step SC003 is executed.

Since “n” is equal to 16, and “j” is equal to 0 at the start of the processing, the process proceeds to step SC003. In step SC003, horizontal pixel count “i” is initialized to 0. Then, horizontal pixel count “i” is compared with horizontal maximum pixel number “m” (step SC004). When (i≧m) is attained, the processing in step SC005 is executed, and otherwise the processing in step SC006 is executed. Since “m” is equal to 16, and “i” is equal to 0 at the start of the processing, the process proceeds to step SC006.

In step SC006, it is determined whether pixel value pixel (i, j) of the current comparison target, i.e., partial image “Ri” at coordinates (i, j) is 0 (white pixel) or not, and pixel value work (i, j) of image “WHi” prepared by one-pixel shifting is 1 (black pixel) or not. When (pixel (i, j)=0 and work (i, j)=1) is attained, the processing in step SC007 is executed. Otherwise, the processing in step SC008 is executed. Referring to FIGS. 9A and 9B, since pixel (0, 0) is 0 and work (0, 0) is 0, the process proceeds to step SC008.

In step SC008, horizontal pixel count “i” is incremented by one (i.e., i=i+1). Since i was initialized to 0, it becomes 1 when 1 is added thereto. Then, the process returns to step SC004. Referring to FIGS. 9A and 9B, since all the pixel values in the 0th row are 0 (white pixels), the processing in steps SC004-SC008 is repeated until (i=15) is attained. When “i” becomes equal to 16 after the processing in step SC008, the state of (cnt=0 and i=16) is attained. In this state, the process proceeds to step SC004. Since the state of (m=16 and i=16) is attained, the process proceeds to step SC005.

In step SC005, vertical pixel count “j” is incremented by one (j=j+1). Since “j” was equal to 0, “j” becomes equal to 1, and the process returns to step SC002. Since a new row starts, the processing is performed in steps SC003 and SC004, similarly to the 0th row. Thereafter, the processing in steps SC004-SC008 is repeated until the state of (i=15 and j=1) is attained, i.e., until the processing of the pixel in the first row and fourteenth column exhibiting the state of (pixel (i, j)=0 and work (i, j)=1) is completed. After the processing in step SC008, “i” is equal to 15. Since the state of (m=16 and i=15) is attained, the process proceeds to step SC006.

In step SC006, pixel (i, j) is 0 and work (i, j) is 1, i.e., pixel (14, 1) is 0 and work (14, 1) is 1 so that the process proceeds to step SC007.

In step SC007, differential count “cnt” is incremented by one (cnt=cnt+1). Since count “cnt” was initialized to 0, it becomes 1 when 1 is added. The process proceeds to step SC008, and the process will proceed to step SC004 when “i” becomes 16. Since (m=16 and i=16) is attained, the process proceeds to step SC005, and will proceed to step SC002 when (j=2) is attained.

Thereafter, the processing in steps SC002-SC009 is repeated for j=2−15 in a similar manner. When (0=15) is attained after the processing in step SC008, vertical pixel count “j” is compared with vertical maximum pixel number “n” in step SC002. When the comparison result indicates (j≧n), the process returns to the steps in the flowchart of FIG. 11, and the processing is executed in step SHT11. Otherwise, the processing in step SC003 is executed. Since (=16 and n=16) is currently attained, the steps in flowchart of FIG. 12 ends, the process returns to the flowchart of FIG. 11 and proceeds to step SHT11. Differential count “cnt” is currently equal to 21.

In step SHT11, the operation of (hcnt=cnt) is performed, and thus difference “cnt” calculated according to the flowchart of FIG. 12 is substituted into increase “hcnt” caused by the leftward and rightward shifting. Then, the process proceeds to step SHT12. In step SHT12, increase “hcnt” that is caused by the horizontal shifting and is equal to 21 is output.

In the feature value calculation processing (step T2a) in FIG. 10, the processing (step ST2) is performed for obtaining increase “vcnt” caused by upward and downward shifting. It is apparent that the processing in steps SVT01-SVT12 in FIG. 12 during the above the processing (step ST2) is basically the same as that in FIG. 11 already described, and description of the processing in steps SVT01-SVT12 is not repeated.

A value of 96 is output as increase “vcnt” caused by the upward and downward shifting. This value of 96 is the difference between image “WVi” obtained by upward and downward one-pixel-shifting and overlapping in FIG. 9C and partial image “Ri” in FIG. 9A.

Output increases “hcnt” and “vcnt” are then processed in and after step ST3 in FIG. 10 as will be described later.

In step ST3, “hcnt”, “vcnt” and lower limit “vcnt0” of the increase in maximum black pixel number in the vertical direction are compared. When the conditions of (vcnt>2×hcnt, and vcnt≧vcnt0) are satisfied, the processing in step ST7 is executed. Otherwise, the processing in step ST4 is executed. The state of (vcnt=96 and hcnt=21) is currently attained, and the process proceeds to step ST7, assuming that “vcnt” is equal to 4. In step ST7, “H” is stored in reference image feature value memory 1024 or in the feature value storage region for partial image “Ri” corresponding to the original image in captured image feature value memory 1025, and the calculation end signal for the partial image feature value is transmitted to control unit 108.

Assuming that the output values of (vcnt=30 and hcnt=20) are output in step ST2 and (vcnt0=4) is attained, the conditions in step ST3 are not satisfied, and the process proceeds to step ST4. When it is determined in step ST4 that the conditions of (hcnt>2×vcnt and hcnt≧hcnt0) are satisfied, the processing in step ST5 is executed. Otherwise, the processing in step ST6 is executed.

In this case, the process proceeds to step ST6, in which “X” is stored in reference image feature value memory 1024 or in the feature value storage region for partial image “Ri” corresponding to the original image in captured image feature value memory 1025, and the calculation end signal for the partial image feature value is transmitted to control unit 108.

Assuming that the values of (vcnt=30 and hcnt=70) are output in step ST2 and (hcnt0=4) is attained, it is determined that the conditions of (vcnt>2×hcnt, and vcnt≧vcnt0) are not satisfied in step ST3, and the process proceeds to step ST4. It is determined in step ST4 whether the conditions of (hcnt>2×vcnt, and hcnt≧hcnt0) are satisfied or not. When satisfied, the processing in step ST5 is executed. Otherwise, the processing in step ST6 is executed.

In this state, the above conditions are satisfied. Therefore, the process proceeds to step ST5. “V” is stored in reference image feature value memory 1024 or in the feature value storage region for partial image “Ri” corresponding to the original image in captured image feature value memory 1025, and the calculation end signal for the partial image feature value is transmitted to control unit 108.

The above calculation of the feature values of the partial image has the following feature. Reference image “A” or captured image “B” may contain noises. For example, the fingerprint image may be partially lost due to wrinkles in the finger or the like. Thereby, as shown in FIG. 9D, a vertical wrinkle may be present in a center of partial image “Ri”. Even in this case, the intended calculation accuracy can be maintained, which is the distinctive feature of the above calculation. More specifically, as illustrated in FIGS. 9E and 9F, it is assumed that the state of (hcnt=29 and vcnt=90) is attained, and the state of (vcnt0=4) is attained. Thereby, the state of (vcnt>2×hcnt, and vcnt≧vcnt0) is attained in step ST3 in FIG. 10 so that the processing in step ST7 is then executed to output value “H” indicating the horizontal direction. As described above, the partial image feature value calculation has the feature that the intended calculation accuracy can be maintained even when the image contains noise components.

As described above, feature value calculate unit 1045 obtains image “WHi” by shifting partial image “Ri” leftward and rightward by a predetermined number of pixel(s), and also obtains image “WVi” by shifting it upward and downward by a predetermined number of pixel(s). Further, feature value calculate unit 1045 obtains increase “hcnt” in number of the black pixels that is the difference between partial image “Ri” and image “WHi” obtained by shifting it leftward and rightward by one pixel, and obtains increase “hcnt” in number of the black pixels that is the difference between partial image “Ri” and image “WVi” obtained by shifting it upward and downward by one pixel. Based on these increases, feature value calculate unit 1045 determines whether the pattern of partial image “Ri” tends to extend horizontally (e.g., to form a lateral stripe), to extent vertically (e.g., to form a longitudinal stripe) or to extend neither vertically nor horizontally. Feature value calculate unit 1045 outputs a value (“H”, “V” or “X”) according to the result of this determination. This output value indicates the feature value of partial image “Ri”.

<Still Another Example of Three Kinds of Feature Values>

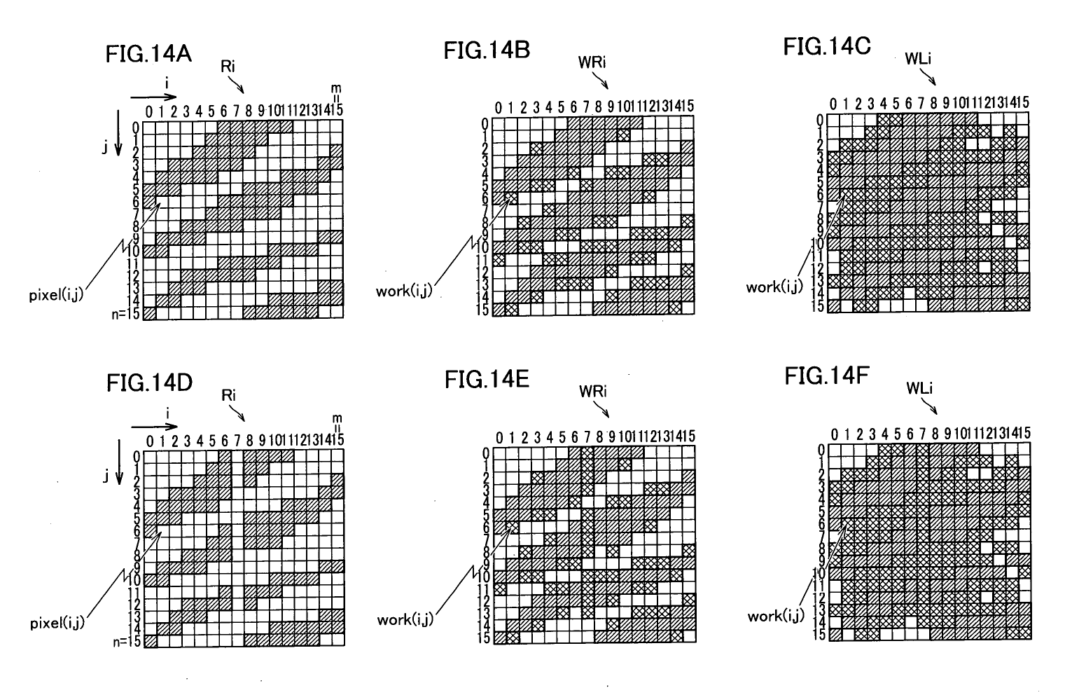

The three kinds of partial image feature values are not restricted to those already described, and may be as follows. The calculation of the partial image feature value is schematically described below according to FIGS. 14A-14F. FIGS. 14A-14F illustrate partial images “Ri” of the image together with the total numbers of the black pixels and white pixels. In these figures, partial image “Ri” is formed of a partial region of 16 by 16 pixels, and thus includes 16 pixels in each of the horizontal and vertical directions. With respect to calculation target partial image “Ri” in FIG. 14A, the processing is performed to obtain increase “rcnt” (i.e., hatched portions in image “WHi” in FIG. 14B) in number of the black pixels that is caused by shifting the calculation target partial image obliquely rightward by one pixel and overlaying the same. Also, the processing is performed to obtain increase “lcnt” (i.e., hatched portions in image “WHi” in FIG. 14C) in number of the black pixels that is caused by shifting the calculation target partial image obliquely leftward by one pixel and overlaying the same. The obtained increases “rcnt” and “lcnt” are compared with each other. When increase “lcnt” is larger than double increase “rcnt”, value “R” indicating the obliquely rightward direction is output. When increase “rcnt” is larger than double increase “lcnt”, value “L” indicating the obliquely leftward direction is output. In other cases, “X” is output. In this manner, the above calculation of the partial image feature value is performed.

The increase of the black pixels caused by shifting the image obliquely rightward represents the following difference. Assuming that (i, j) represents the coordinate of each pixel in the original image of 16 by 16 pixels, an image is prepared by shifting the original image to change the coordinate (i, j) of each pixel to (i+1, j−1), and another image is also prepared by shifting the original image to change the coordinate (i, j) of each pixel to (i−1, j+1). The two images thus formed are overlaid on the original image to prepare the overlapping image (16 by 16 pixels) such that the pixels at the same coordinates (i, j) match together. The foregoing increase indicates the difference in total number of the black pixels between the overlapping image thus formed and the original image.

The increase of the black pixels caused by shifting the image obliquely leftward represents the following difference. Assuming that (i, j) represents the coordinate of each pixel in the original image of 16 by 16 pixels, an image is prepared by shifting the original image to change the coordinate (i, j) of each pixel to (i−1, j−1), and another image is also prepared by shifting the original image to change the coordinate (i, j) of each pixel to (i+1, j−1). The two images thus formed are overlaid on the original image to prepare the overlapping image (16 by 16 pixels) such that the pixels at the same coordinates (i, j) match together. The foregoing increase indicates the difference in total number of the black pixels between the overlapping image thus formed and the original image.

In this case, when the black pixels of certain pixels overlap together, the black pixel is formed. When the white and block pixels overlap together, the black pixel is formed. When the while pixels overlap together, the white pixel is formed.

However, even when it is determined to output “R” or “L”, “X” will be output when the increase of the black pixels is smaller than the lower limit value “lcnt0” and “rcnt0” that are preset for the opposite directions, respectively. This can be expressed by the conditional equations as follows. When (1) lcnc>2×rcnt and (2) lcnt≧lcnt0 are attained, “R” is output. When (3) rcnt>2×lcnt and (4) rcnt≧rcnt0 are attained, “L” is output. Otherwise, “X” is output.

Although “R” indicating the obliquely rightward direction is output when increase “lcnt” is larger than double increase “rcnt”, the threshold, i.e., double the value may be changed to another value. This is true also with respect to the obliquely leftward direction. In some cases, it is known in advance that the number of black pixels in the partial image falls within a certain range (e.g., 30%-70% of the whole pixel number in partial image “Ri”), and that the image can be appropriately used for the comparison. In these cases, the above conditional equations (2) and (4) may be eliminated.

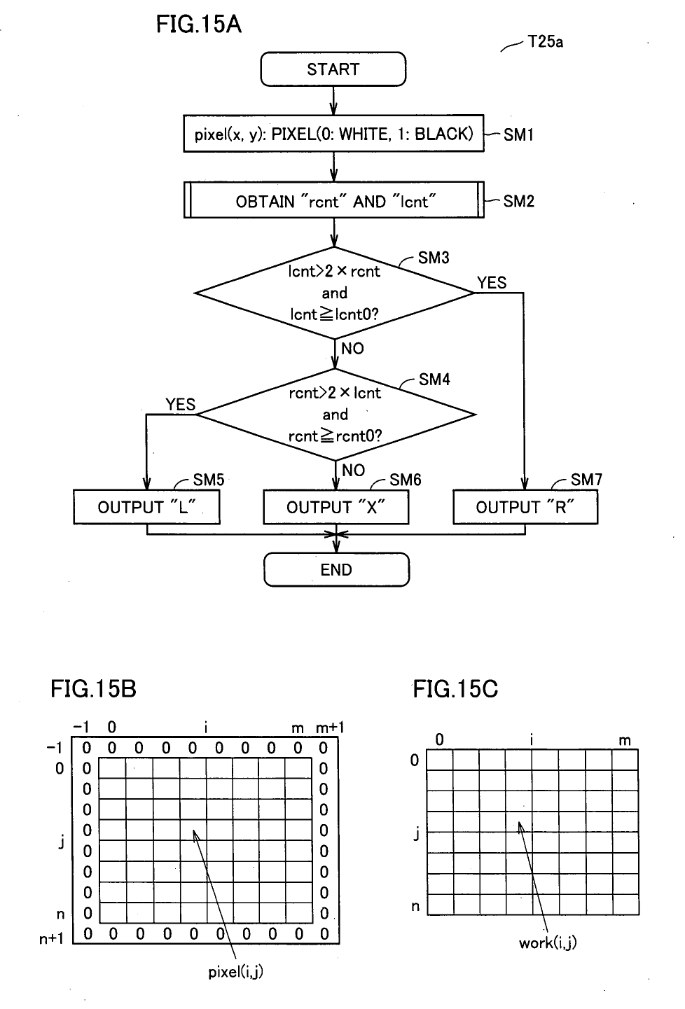

FIG. 15A is a flowchart of another processing of calculating the partial image feature value. The processing in this flowchart is repeated for partial images “Ri” of N in number of reference image “A” which is a calculation target and is stored in reference memory 1021. Reference image feature value memory 1024 stores result values of this calculation in a fashion correlated to respective partial images “Ri”. Likewise, the processing is repeated for partial images “Ri” of N in number of captured image “B” in captured image memory 1023. Captured image feature value memory 1025 stores result values of this calculation in a fashion correlated to respective partial images “Ri”. Details of the calculation of the partial image feature value will be described with reference to FIG. 15.

First, control unit 108 transmits the calculation start signal for the partial image feature value to feature value calculate unit 1045, and then waits for reception of the calculation end signal for the partial image feature values.

Feature value calculate unit 1045 reads partial images “Ri” (see FIG. 14A) of the calculation target images from reference memory 1021 or captured image memory 1023, and temporarily stores them in calculation memory 1022 (step SM1). Feature value calculate unit 1045 reads stored partial image “Ri”, and obtains increase “rcnt” by shifting it obliquely rightward as illustrated in FIG. 14B as well as increase “lcnt” by shifting it obliquely leftward as illustrated in FIG. 14C (step SM2).

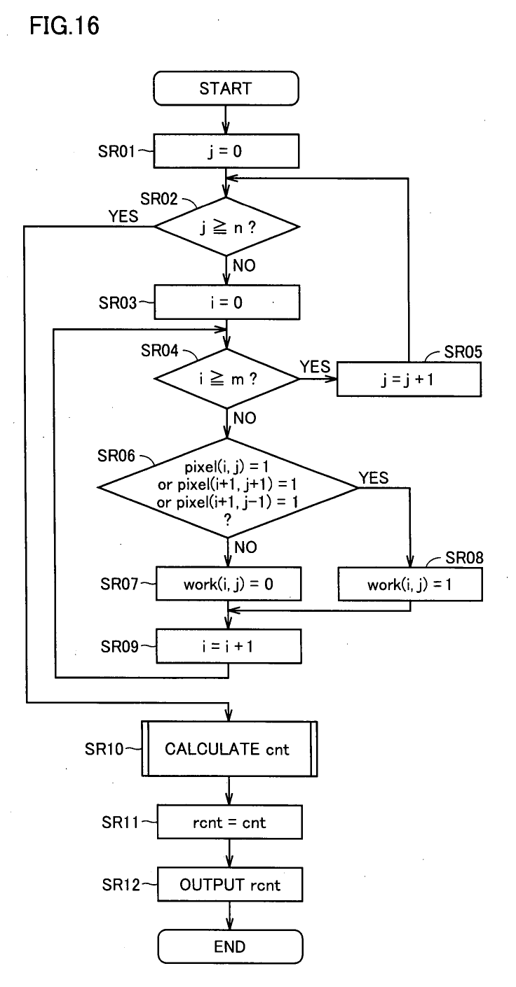

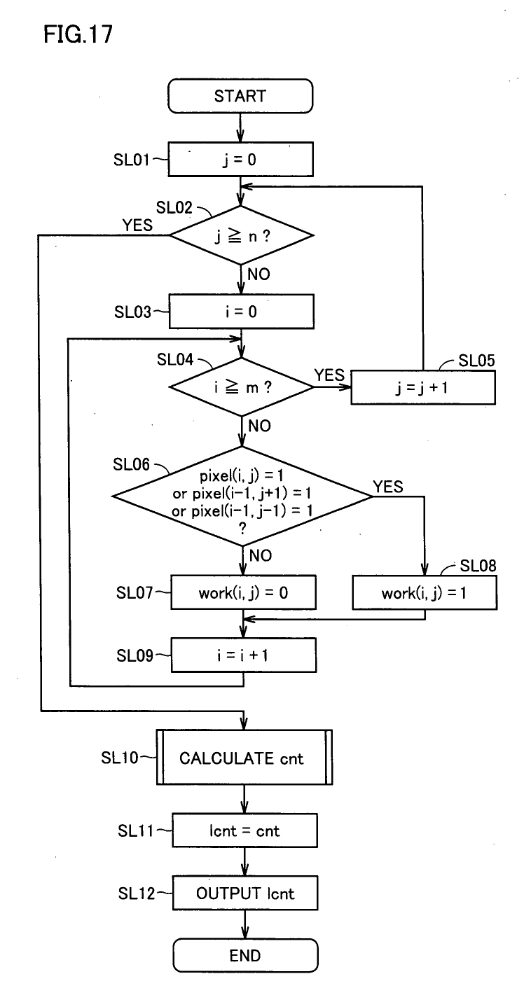

The processing for obtaining increases “rcnt” and “lcnt” will now be described with reference to FIGS. 16 and 17. FIG. 16 is a flowchart of processing (step SM2) of obtaining increase “rcnt” caused by the obliquely rightward shifting. This processing is performed in the processing (step T2a) of calculating the partial image feature value.

Referring to FIG. 16, feature value calculate unit 1045 reads partial image “Ri” from calculation memory 1022, and initializes pixel count “j” in the vertical direction to zero (j=0) in step SR01. Then, feature value calculate unit 1045 compares pixel count “j” in the vertical direction with maximum pixel number “n” in the vertical direction (step SR02). When the comparison result is (j≧n), step SR10 is executed. Otherwise, next step SR03 is executed. Since “n” is equal to 16 and “j” is equal to 0 at the start of the processing, the process proceeds to step SR03.

In step SR03, feature value calculate unit 1045 initializes pixel count “i” in the horizontal direction to zero (i=0). Then, feature value calculate unit 1045 compares pixel count “i” in the horizontal direction with maximum pixel number “m” in the horizontal direction (step SR04). When the comparison result is (i≧m), step SR05 is executed. Otherwise, next step SR06 is executed. Since “m” is equal to 16, and “j” is equal to 0 at the start of the processing, the process proceeds to step SR06.

In step SR06, partial image “Ri” is read, and it is determined whether the current comparison target, i.e., pixel value pixel (i, j) at coordinates (i, j) is 1 (black pixel) or not, whether pixel value pixel (i+1, j+1) at coordinates (i+1, j+1) shifted toward the upper right by one from coordinates (i, j) is 1 or not, or whether pixel value pixel (i+1, j−1) at coordinates (i+1, j−1) shifted obliquely rightward by one from coordinates (i, j) is 1 or not. When (pixel (i, j)=1, pixel (i+1, j+1)=1 or pixel (i+1, j−1)=1) is attained, step SR8 is executed. Otherwise, step SR07 is executed.

In a range defined by pixels shifted horizontally or vertically by one pixel from partial image “Ri”, i.e., in a range defined by pixels of Ri(−1−m+1, −1), Ri(−1, −1−n+1), Ri(m+1, −1−n+1) and Ri(−1−m+1, n+1), it is assumed that the pixels take the values of 0 (and are white) as illustrated in FIG. 15B. Referring to FIG. 14A, since the state of (pixel (0, 0)=0, pixel (−1, 0)=0 and pixel (1, 0)=0) is attained, the process proceeds to step SR07.

In step SR07, pixel value work (i, j) at coordinates (i, j) of image “WHi” stored in calculation memory 1022 is set to 0. This image “WVHi” is prepared by overlaying, on the original image, the images shifted obliquely rightward by one pixel (see FIG. 15C). Thus, the state of (work (0, 0)=1) is attained. Then, the process proceeds to step SR09.

In step SR09, (i=i+1) is attained, and thus horizontal pixel count “i” is incremented by one. Since “i” was initialized to 0, “i” becomes 1 when 1 is added thereto. Then, the process returns to step SR04.

In step SR05, (j=j+1) is performed. Thus, vertical pixel count “j” is incremented by one. Since “j” was equal to 0, “j” becomes 1, and the process returns to step SR02. Since the processing on a new row starts, the process proceeds to steps SR03 and SR04, similarly to the 0th row. Thereafter, processing in steps SR04-SR09 will be repeated until (pixel (i, j)=1) is attained, i.e., the pixel in the first row and fifth column (i=5 and j=1) is processed. After the processing in step SR09, (i=5) is attained. Since the state of (m=16 and i=5) is attained, the process proceeds to step SR06.

In step SR06, (pixel (i, j)=1), i.e., (pixel (5, 1)=1) is attained so that the process proceeds to step SR08.

In step SR08, pixel value work (i, j) at coordinates (i, j) of image “WRi” stored in calculation memory 1022 is set to one.

The process proceeds to step SR09. “i” becomes equal to 16 and the process proceeds to step SR04. Since the state of (m=16 and i=16) is attained, the process proceeds to step SR05, “j” becomes equal to 2 and the process proceeds to step SR02. Thereafter, the processing in steps SR02-SR09 is repeated similarly for j=2−15. When “j” becomes equal to 16 after the processing in step SR09, the processing is performed in step SR02 to compare the value of vertical pixel count “J” with vertical maximum pixel number “n”. When the result of comparison indicates (j≧n), the processing in step SR10 is executed. Otherwise, the processing in step SR03 is executed. Since the state of (j=16 and n=16) is currently attained, the process proceeds to step SR10. At this time, calculation memory 1022 has stored image “WRi” prepared by overlaying, on partial image “Ri” to be currently compared for comparison, images prepared by shifting partial image “Ri” obliquely rightward by one pixel.

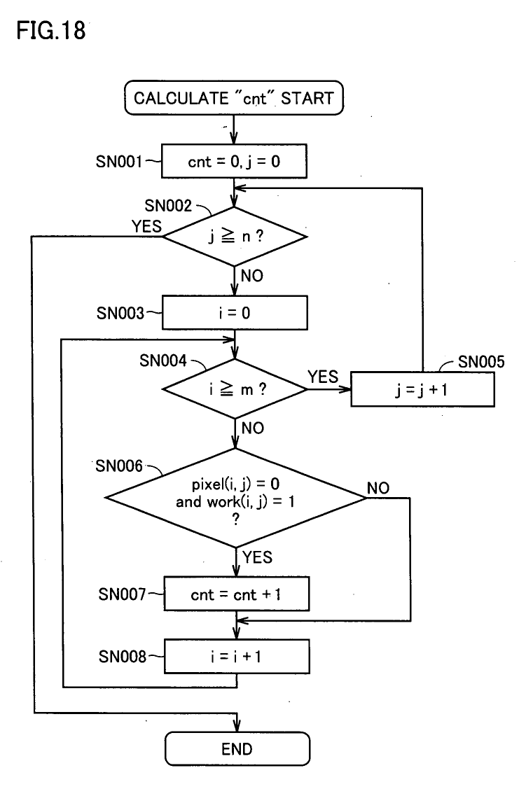

In step SR 10, calculation is performed to obtain difference “cnt” between pixel value work (i, j) of image “WRi” stored in calculation memory 1022 and prepared by overlaying images shifted obliquely rightward by one pixel and pixel value pixel (i, j) of partial image “Ri” that is currently compared for comparison. The processing of calculating difference “cnt” between “work” and “pixel” will now be described with reference to FIG. 18.

FIG. 18 is a flowchart for calculating difference “cnt” in pixel value pixel (i, j) between partial image “Ri” that is currently compared for comparison and image “WRi” that is prepared by overlaying, on partial image “Ri”, the images prepared by shifting the image obliquely rightward or leftward by one pixel. Feature value calculate unit 1045 reads, from calculation memory 1022, partial image “Ri” and images “WRi” prepared by one-pixel shifting and overlaying, and initializes difference count “cnt” and vertical pixel count “j” to attain (cnt=0 and j=0) (step SN001). Then, vertical pixel count “j” is compared with vertical maximum pixel number “n” (step SN002). When the comparison result indicates j≧n), the process returns to steps in the flowchart of FIG. 16, and “cnt” is substituted into “rcnt” in step SR11. Otherwise, the processing in step SN003 is executed.

Since “n” is equal to 16, and “j” is equal to 0 at the start of the processing, the process proceeds to step SN003. In step SN003, horizontal pixel count “i” is initialized to 0. Then, horizontal pixel count “i” is compared with horizontal maximum pixel number “m” (step SN004). When the comparison result indicates (i≧m), the processing in step SN005 is executed, and otherwise the processing in step SN006 is executed. Since “m” is equal to 16, and “i” is equal to 0 at the start of the processing, the process proceeds to step SN006.

In step SN006, it is determined whether pixel value pixel (i, j) of the current comparison target, i.e., partial image “Ri” at coordinates (i, j) is 0 (white pixel) or not, and pixel value work (i, j) of image “WRi” prepared by one-pixel shifting is 1(black pixel) or not. When (pixel (i, j)=0 and work (i, j)=1) is attained, the processing in step SN007 is executed. Otherwise, the processing in step SN008 is executed. Referring to FIGS. 14A and 14B, since pixel (0, 0) is 1 and work (0, 0) is 0, the process proceeds to step SN008.

In step SN008, horizontal pixel count “i” is incremented by one (i.e., i=i+1). Since i was initialized to 0, it becomes 1 when 1 is added thereto. Then, the process returns to step SN004. The processing in steps SN004-SN008 is repeated until (i=15) is attained. When “i” becomes equal to 16 after the processing in step SN008, the process proceeds to step SN004. Since the state of (m=16 and i=16) is attained, the process proceeds to step SN005.

In step SN005, vertical pixel count “j” is incremented by one (j=j+1). Since “j” was equal to 0, “j” becomes equal to 1, and the process returns to step SN002. Since a new row starts, the processing is performed in steps SN003 and SN004, similarly to the 0th row. Thereafter, the processing in steps SN004-SN008 is repeated until the state of (i=10 and j=1) is attained, i.e., until the processing of the pixel in the first row and eleventh column exhibiting the state of (pixel (i, j)=0 and work (i, j)=1) is completed. After the processing in step SN008, “i” is equal to 10. Since the state of (m=16 and i=10) is attained, the process proceeds to step SN006.

In step SN006, pixel (i, j) is 0 and work (i, j) is 1, i.e., pixel (10, 1) is 0 and work (10,) is 1 so that the process proceeds to step SN007.

In step SN007, differential count “cnt” is incremented by one (cnt=cnt+1). Since count “cnt” was initialized to 0, it becomes 1 when 1 is added. The process proceeds to step SN008, and the process will proceed to step SN004 when “i” becomes 16. Since (m=16 and i=16) is attained, the process proceeds to step SN005, and will proceed to step SN002 when (j=2) is attained.

Thereafter, the processing in steps SN002-SN009 is repeated for j=2−15 in a similar manner. When (=16) is attained after the processing in step SN008, vertical pixel count “j” is compared with vertical maximum pixel number “n” in step SN002. When the comparison result indicates (j≧n), the process returns to the steps in the flowchart of FIG. 12, and the processing is executed in step SR11. Otherwise, the processing in step SN003 is executed. Since (j=16 and n=16) is currently attained, the steps in flowchart of FIG. 18 end, the process returns to the flowchart of FIG. 16 and proceeds to step SR11. Differential count “cnt” is currently equal to 21.

In step SR11, the operation of (rcnt=cnt) is performed, and thus difference “cnt” calculated according to the flowchart of FIG. 18 is substituted into increase “rcnt” caused by the obliquely rightward shifting. Then, the process proceeds to step SR12. In step SR12, increase “rcnt” that is caused by obliquely rightward shifting and is equal to 21 is output.

In the feature value calculation processing (step T2a) in FIG. 18, the processing (step SM2) is performed for obtaining increase “lcnt” caused by the obliquely leftward shifting. It is apparent that the processing in steps SL01-SL12 in FIG. 17 during the above the processing (step SM2) is basically the same as that in FIG. 16 already described, and description of the processing in steps SL01-SL12 is not repeated.

A value of 115 is output as increase “lcnt” caused by the obliquely leftward shifting. This value of 115 is the difference between image “WLi” obtained by obliquely leftward one-pixel shifting and overlapping in FIG. 14C and partial image “Ri” in FIG. 14A.

Output increases “rcnt” and “lcnt” are then processed in and after step SM3 in FIG. 15 as will be described later.

In step SM3, “rcnt”, “lcnt” and lower limit “vlcnt0” of the increase in maximum black pixel number in the obliquely leftward direction are compared. When the conditions of (lcnt>2×rcnt, and lcnt≧lcnt0) are satisfied, the processing in step SM7 is executed. Otherwise, the processing in step SM4 is executed. The state of (lcnt=115 and rcnt=21) is currently attained, and the process proceeds to step SM7, assuming that “lcnt” is equal to 4. In step SM7, “R” is stored in reference image feature value memory 1024 or in the feature value storage region for partial image “Ri” corresponding to the original image in captured image feature value memory 1025, and the calculation end signal for the partial image feature value is transmitted to control unit 108.

When it is assumed that the values of (lcnt=30 and rcnt=20) are output in step SM2 and (lcnt0=4) is attained, the process proceeds to step SM4. When the conditions of (rcnt>2×lcnt, and rcnt≧rcnt0) are satisfied, the processing in step SM5 is executed. Otherwise, the processing in step SM6 is executed.

In this case, the process proceeds to step SM6, in which “X” is stored in reference image feature value memory 1024 or in the feature value storage region for partial image “Ri” corresponding to the original image in captured image feature value memory 1025, and the calculation end signal for the partial image feature value is transmitted to control unit 108.

Assuming that the values of (lcnt=30, rcnt=70) are output in step SM2 and (lcnt0=4 and rcnt0=4) is attained, the conditions of (lcnt>2×rcnt, and lcnt≧lcnt0) in step SM3 are not satisfied, and the process proceeds to step SM4. When the conditions of (rcnt>2×lcnt, and rcnt≧rcnt0) are satisfied in SM4, the processing in step SM5 is executed. Otherwise, the processing in step SM6 is executed.

In this state, the process proceeds to step SM5. “L” is stored in reference image feature value memory 1024 or in the feature value storage region for partial image “Ri” corresponding to the original image in captured image feature value memory 1025, and the calculation end signal for the partial image feature value is transmitted to control unit 108.

The above calculation of the feature values has the following feature. Reference image “A” or captured image “B” may contain noises. For example, the fingerprint image may be partially lost due to wrinkles in the finger or the like. Thereby, as shown in FIG. 14D, a vertical wrinkle may be present in a center of partial image “Ri”. Even in this case, the intended calculation accuracy can be maintained, which is the distinctive feature of the above calculation. More specifically, as illustrated in FIGS. 14E and 14F, it is assumed that the state of (rcnt=57 and lcnt=124) is attained, and the state of (lcnt0=4) is attained. Thereby, the conditions of (lcnt>2×rcnt, and lcnt≧lcnt0) is attained in step SM3 in FIG. 15 so that the processing in step SM7 is then executed to output value “R”. As described above, the partial image feature value calculation has the feature that the intended calculation accuracy can be maintained even when the image contains noise components.

As described above, feature value calculate unit 1045 obtains image “WRi” by shifting partial image “Ri” obliquely rightward by a predetermined number of pixel (s), and also obtains image “WLi” by shifting it obliquely leftward by a predetermined number of pixel (s). Further, feature value calculate unit 1045 obtains increase “rcnt” in number of the black pixels that is the difference between partial image “Ri” and image “WRi” obtained by shifting it obliquely rightward by one pixel, and obtains increase “rcnt” in number of the black pixels that is the difference between partial image “Ri” and image “WLi” obtained by shifting it obliquely leftward by one pixel. Based on these increases, feature value calculate unit 1045 determines whether the pattern of partial image “Ri” tends to extend obliquely rightward (e.g., to form a obliquely rightward stripe), to extent obliquely leftward (e.g., to form a obliquely rightward stripe) or to extend in any other direction. Feature value calculate unit 1045 outputs a value (“R”, “L” or “X”) according to the result of this determination.

<Five Kinds of Feature Values>

Feature value calculate unit 1045 may be configured to output all kinds of the feature values already described. In this case, feature value calculate unit 1045 obtains increases “hcnt”, “vcnt”, “rcnt” and “lcnt” of the black pixels according to the foregoing steps. Based on these increases, feature value calculate unit 1045 determines whether the pattern of partial image “Ri” tends to extend horizontally (e.g., lateral stripe), vertically (e.g., longitudinal stripe), obliquely rightward (e.g., obliquely rightward stripe), obliquely leftward (e.g., obliquely leftward stripe) or in any other direction. Feature value calculate unit 1045 outputs a value (“H”, “V”, “R”, “L” or “X”) according to the result of the determination. This output value indicates the feature value of partial image “Ri”.

In this example, “H” and “V” are used in addition to “R”, “L” and “X” as the feature values of partial image “Ri”. Therefore, the feature values of the partial image of the comparison target image can be classified more closely. Therefore, even “X” is issued for a certain partial image when the classification is performed based on the three kinds of feature values, this partial image may be classified to output a value other than “X” when the classification is performed based on the five kinds of feature values. Therefore, the partial image “Ri” to be classified to issue “X” can be detected more precisely.

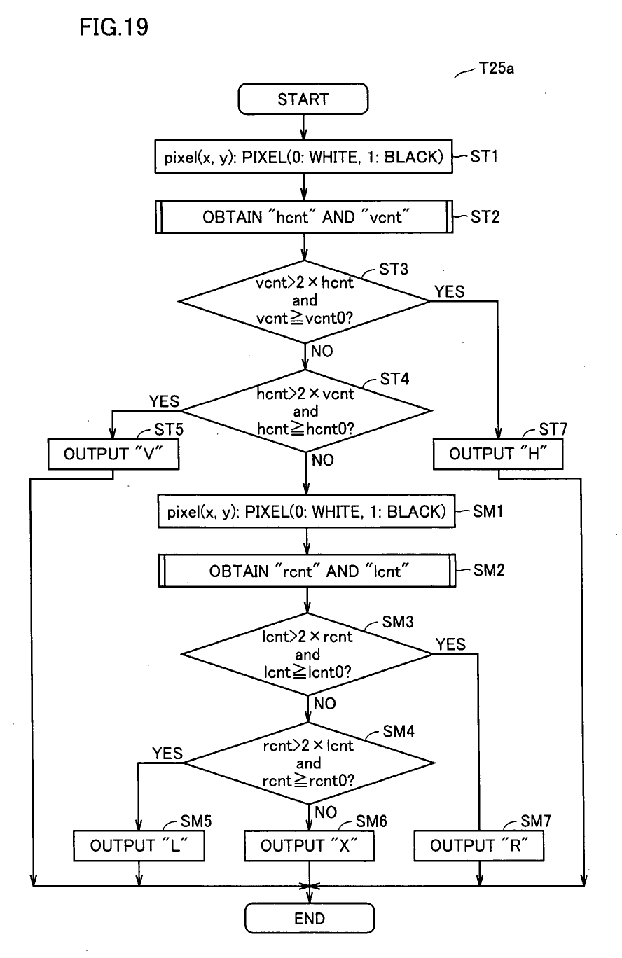

FIG. 19 is a flowchart of calculation for the five kinds of feature values. According to the calculation of the partial image feature values in FIG. 19, processing similar to that in steps ST1-ST4 in the processing (T2a) of the calculation of partial image feature values is first executed, and the determination result of “V” or “H” is provided (steps ST5 and ST7). When the determination result is neither “V” nor “H” (NO in step ST4), processing similar to that in steps SM1-SM7 of the image feature value calculation is executed, and “L”, “X” and “R” are output as the determination result. Thereby, the calculation of the partial image feature value in step T25a can output the five kinds of partial image feature values of “V”, “H”, “L”, “R” and “X”.

In this example, the processing in FIG. 10 is first executed in view of such a tendency that the fingerprints of the determination targets have patterns extending longitudinally or laterally in many cases. However, this execution order is not restrictive. The processing in FIG. 15 may be executed first, and then the processing in FIG. 10 may be executed when the result is neither “L” nor “R”.

<Restriction of Search Target>

The target of search by maximum matching score position searching unit 105 can be restricted according to the feature values calculated as described before.

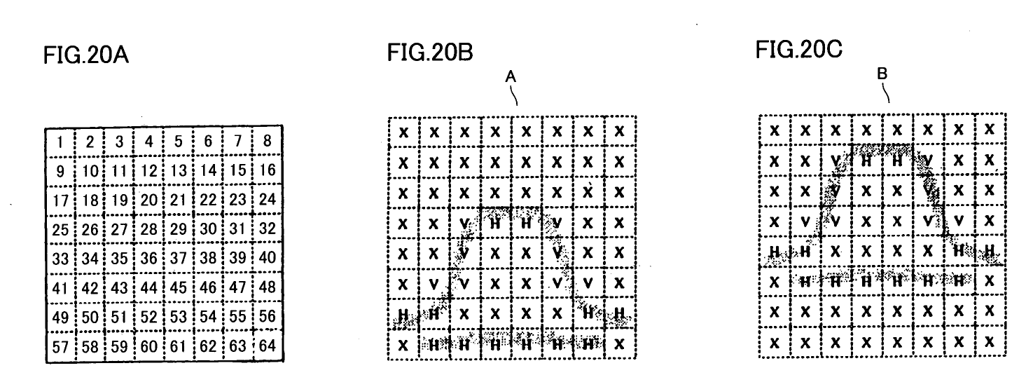

FIGS. 20A and 20B schematically show examples of images “A” and “B” from which the partial image feature values are calculated after image input (T1) and image correction (T2) are performed.

Referring to FIG. 20A, the partial image position in the image is specified as follows. The image in FIG. 20A has the same configuration (shape and size) as images “A” and “B” in FIGS. 20B and 20C. Partial images “Ri” of the same rectangular shape are prepared by equally dividing the image in FIG. 20A into 64 portions. These 64 partial images “Ri” are successively assigned numeric values of 1-64 in the order from the upper right toward the lower left so that these numeric values indicate the positions of partial images “Ri” in image “A” or “B”, respectively. The 64 partial images “Ri” in the image are indicated as partial image “g1”, partial image “g2”, and partial image “g64”, using the assigned numeric values indicating the corresponding positions, respectively. Since the images in FIGS. 20A, 20B and 20C have the same configurations, each of images “A” and “B” in FIGS. 20B and 20C have 64 partial images “Ri” that are the same as those in FIG. 20A, and the positions of these partial image “Ri” can be specified as partial image “g1”, partial image “g2”, . . . and partial image “g64”, respectively. Maximum matching score position searching unit 105 searches for partial image “Ri” at the maximum matching score position in each of images “A” and “B”, and this searching is performed in the order of partial images “g1”, partial image “g2”, . . . and partial image “g64”. It is assumed that each of the partial images in the images of FIGS. 20B and 20C has the feature value which is the same as one of feature values “H”, “V” and “X” calculated by feature value calculate unit 1045.

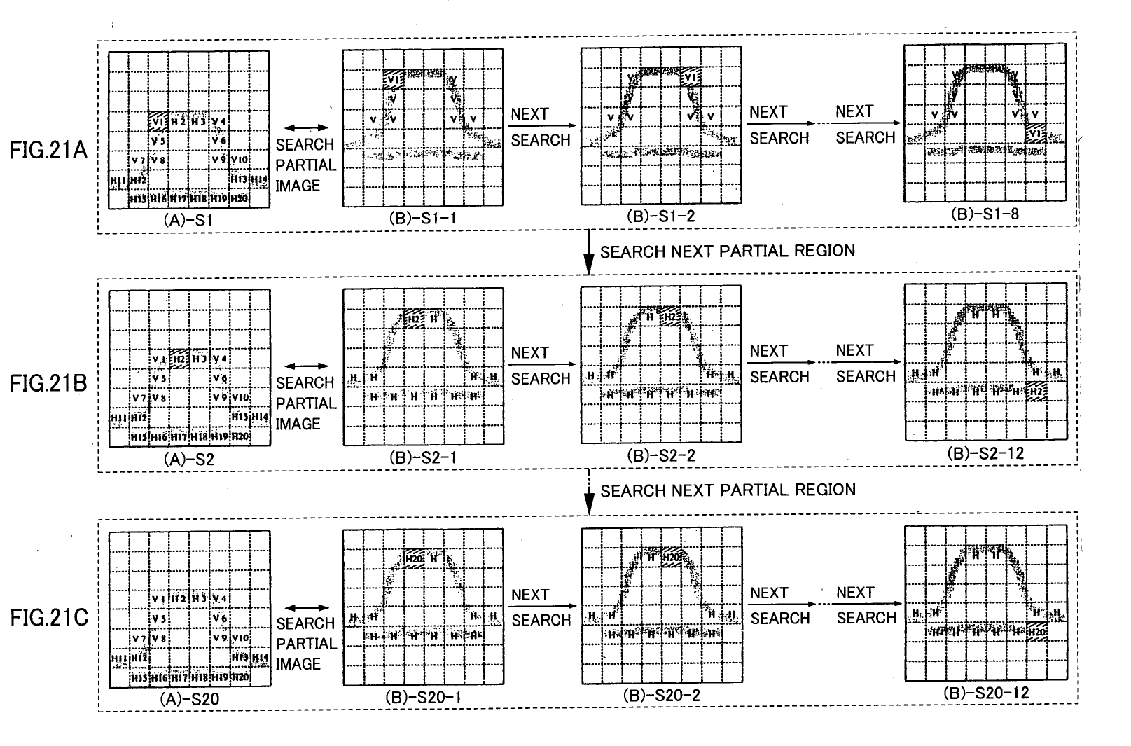

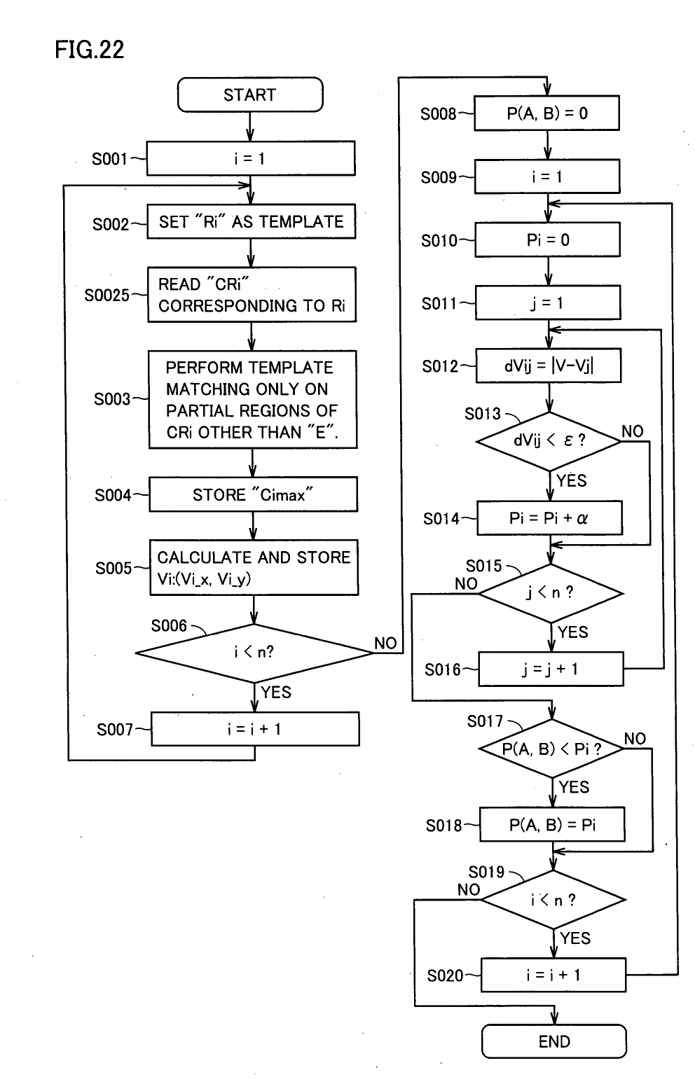

FIGS. 21A-21C illustrate the steps of finding the maximum matching score position in images “A” and “B” in FIGS. 20B and 20C from which the feature values of the partial images are calculated. FIG. 22 is a flowchart of the processing for finding the maximum matching score position and calculating the similarity score.

Maximum matching score position searching unit 105 searches image “A” in FIG. 20B for the partial images that have the feature value of “H” or “V”, and particularly have the same feature value in image “B”. Accordingly, when maximum matching score position searching unit 105 first finds the partial image having the feature value of “H” or “V” after it started the searching for the partial image in image “A”, the found partial image becomes the first search target. In an image (A)-S1 in FIG. 21A, the partial image feature values are represented for the partial images of image “A”, and partial image “g27” (i.e., V1) appearing first as the image having the feature value of “H” or “V” is hatched.

As can be seen from image (A)-S1, first-found partial image feature value indicates “V”. In image “B”, therefore, the partial image having the feature value of “V” is to be found. In an image (B)-S2-1 illustrated in FIG. 21A, when image “B” is searched for the partial image having the feature value “V”, partial image “g1” (i.e., “V1”) is first found, and is hatched. This image is subjected to the processing in steps S002-S007 in FIG. 22.

In image “B”, the processing is then performed on partial image “g14” (i.e., “V1”) following partial image “g11” and having feature value “V” (image (B)-S1-2 in FIG. 21A). Thereafter, the processing is performed on partial images “g19”, “g22”, “g26”, “g27”, “g30” and “g31” (image (B)-S1-8 in FIG. 20A). When a series of searching operations is completed in image “B” in connection with partial image “g27” having the feature value of “H” or “V” appearing first in image “A”, the processing in steps S002-S007 in FIG. 22 is then performed in substantially the same manner on partial image “g28” (image (A)-S2 in FIG. 21B) having the next feature value “H” or “V”. Since the partial image feature value of partial image “g28” is “H”, a series of search processing is performed on the partial images having the feature value of “H” in image “B”, i.e., partial image “g12” (image (B)-S2-1 in FIG. 21B), partial image “g13” (image (B)-S2-2 in FIG. 21B), partial images “g33”, “g34”, “g39”, “g40”, “g42”-“g46” and “47” (image (B)-S2-12 in FIG. 21B).

Thereafter, the search processing is performed on image “B” in the substantially same manner for partial images having the feature value of “H” and “V” in image “A”, i.e., partial images “g29”, “g30”, “g35”, “g38”, “g42”, “g43”, “g46”, “g47”, “g49”, “g50”, “g55”, “g56”, “g58”-“g62” and “g63” (image (A)-S20 in FIG. 21C).

Therefore, the number of the partial images searched for in images “A” and “B” by maximum matching score position searching unit 105 is obtained by ((the number of partial images in image “A” having partial image feature value “V”)×(the number of partial images in image “B” having partial image feature value “V”)+(the number of partial images in image “A” having partial image feature value “H”)×(the number of partial images in image “B” having partial image feature value “H”). Referring to FIGS. 21A-21C, the number of the searched partial images is equal to (8×8+12×12=208).

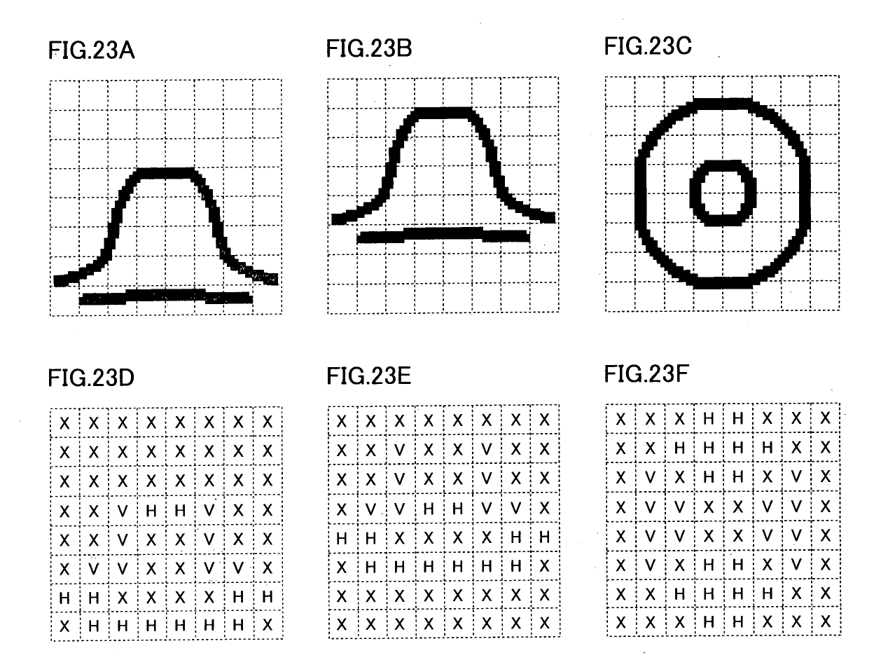

Since the partial image feature value also depends on the pattern represented by the image, description will now be given on images representing patterns different from those in FIGS. 20A and 20B. FIGS. 23A and 23B shows images “A” and “B” of the patterns different from those of images “A” and “B” in FIGS. 20B and 20C, respectively. FIG. 23C shows an image “C” representing a pattern different from that of image “B” in FIG. 20C.

FIGS. 23D, 23E and 23F represent the feature values that are calculated by feature value calculate unit 1045 from the partial images of images “A”, “B” and “C” in FIGS. 23A, 23B and 23C, respectively.

When images “A” and “C” in FIGS. 23A and 23C are search targets, the number of the partial images searched by maximum matching score position searching unit 105 is likewise obtained by ((the number of partial images in image “A” having partial image feature value “V”)×(the number of partial images in image “C” having partial image feature value “V”)+(the number of partial images in image “A” having partial image feature value “H”)×(the number of partial images in image “C” having partial image feature value “H”). Referring to FIGS. 23D and 23F, the number of the searched partial images is equal to (8×12+12×16=288).

In the above description, the partial images having the same feature value are handled as the search target. However, this is not restrictive, and another manner may be naturally employed, e.g., in view of improvement of the comparison accuracy. For example, the feature values of the partial images of the captured image for the search targets may be determined as follows. In addition to the partial regions of “H”, partial regions of “X” are handled as the search target when the feature value of the reference partial image is “H”. Also, in addition to the partial regions of “V”, partial regions of “X” are handled as the search target when the feature value of the reference partial image is “V”.

When the feature value is “X”, the pattern of the partial image can be determined as neither the longitudinal stripe nor lateral stripe. However, for improving the comparison speed, the partial region exhibiting “X” may be removed from the search range of maximum matching score position searching unit 105.

For improving the accuracy, the values of “L” and “R” may be employed in addition to “H” and “V”.

<Determination of Comparison-Untargeted Image Element>

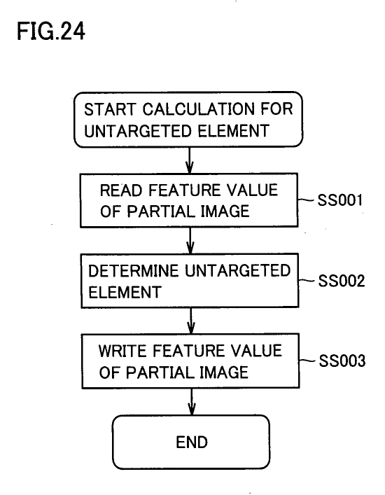

After the image is subjected to the correction by image correcting unit 104 and the calculation of the feature values of the partial images by feature value calculate unit 1045, it is subjected to processing (step T25b) of determination/calculation for comparison-untargeted image elements. FIG. 24 is a flowchart illustrating this processing.

It is now assumed that each partial image in the image of the comparison target exhibits the feature value of “H”, “V”, “L” or “R” (in the case of the four kinds of values) when it is processed by element determining unit 1047. More specifically, when fingerprint read surface 201 of fingerprint sensor 100 has a stained region or a fingerprint (i.e., finger) is not placed on a certain region, the image cannot be entered through such regions. In this situation, the partial image corresponding to the above region basically takes the feature value of “X”. Using this, element determining unit 1047 detects and determines that the stained partial region in the input image and the partial region unavailable for input of the fingerprint image are the comparison-untargeted image elements, i.e., the image elements other than the comparison target. Element determining unit 1047 assigns the feature value of “E” to the regions thus detected. The fact that the feature value of “E” is assigned to the partial regions (partial image) of the image means that these partial regions (partial images) are excepted from the search range which is searched by maximum matching score position searching unit 105 for the image comparison by comparison determining unit 107, and are excepted from the targets of the similarity score calculation by similarity score calculate unit 106.

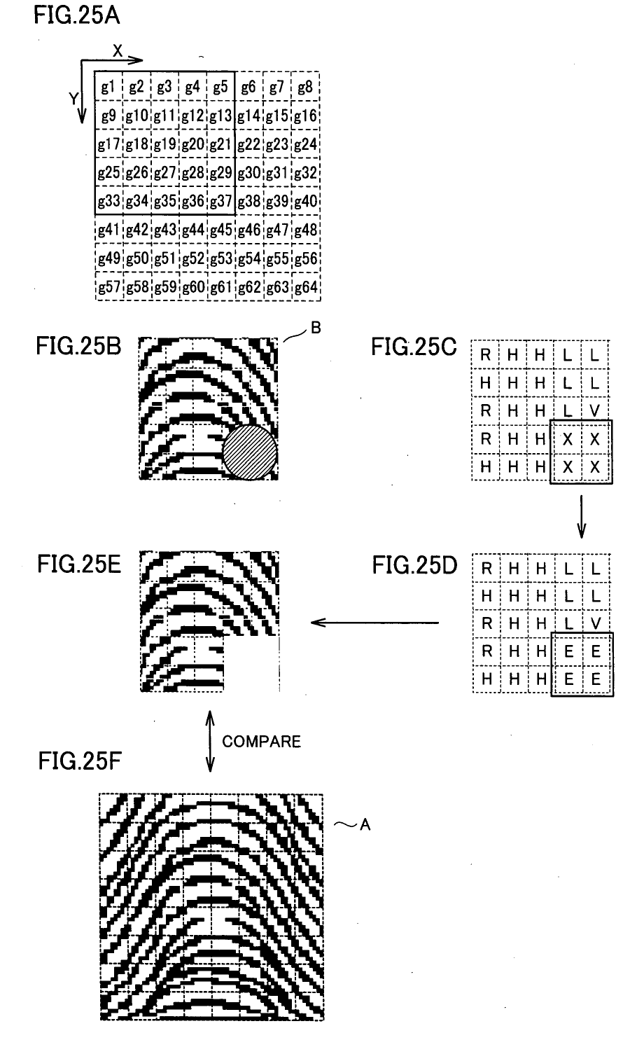

FIGS. 25A-25F schematically illustrates the determination of the comparison-untargeted image elements as well as the comparison. FIGS. 25B and 25F schematically illustrate input image “B” and reference image “A”. As illustrated in FIG. 25A, reference image “A” is equally divided into 8 portions in each of the lateral and longitudinal directions, and therefore into 64 partial images having the same size and shape. In FIG. 25A, the 64 partial images are assigned the numeric values indicating the image positions from “g1” to “g64”, respectively. Input image “B” in FIG. 25B has a stained portion indicated by hatched circle.

Input image “B” in FIG. 25B is divided into five in each of the longitudinal and lateral directions, and therefore into 25 partial images having the same size and shape. These 25 partial images are located at the positions that are indicated by “g1”-“g51”, “g9”-“g13”, “g17”-“g21”, “g25”-“g29” and “g33”-“g37” in FIG. 25A. For the sake of illustration, it is assumed that the calculated feature value of each partial image in reference image “A” takes the value (“H”, “V”, “L” or “R”) except for “X” and “E”.

Element determining unit 1047 reads the feature value calculated by feature value calculate unit 1045 for each of the partial images corresponding to input image “B” in FIG. 25B, and provides the feature value thus read to calculation memory 1022. FIG. 25C illustrates the state of such reading (step SS001 in FIG. 24).

Element determining unit 1047 searches the feature values of the respective partial images in FIG. 25C stored in calculation memory 1022 in the ascending order of the numeric values indicating the partial image positions, and thereby detects the comparison-untargeted image elements (step SS002 in FIG. 24). In this process of searching, when the partial image having the feature value of “X” is detected, the feature value of the partial image neighboring to the partial image in question is obtained. By the search, the partial image having the feature value of “X” may be detected in the position neighboring to the above partial image in question in one of the longitudinal direction (Y-axis direction), lateral direction (X-axis direction) and oblique directions (inclined by 45 degrees with respect to the X- and Y-axes). When the above partial image is detected, a set or combination of the partial image in question and the neighboring partial image thus detected is detected and determined as the comparison-untargeted image element.

More specifically, the feature values of the partial images of input image “B” illustrated in FIG. 25C stored in calculation memory 1022 are determined in the order of “g1”, “g2”, “g3”, “g4”, “g5”, “g9”, . . . , “g13” and “g17”. During this determination, the partial image having the feature value of “X” or “E” may be detected. In this case, the search processing is performed to obtain the feature values of all the partial images neighboring to this partial image in question and particularly located in the upper, lower, left, right, upper right, lower right, upper left and lower left positions, respectively. When the feature value of “X” is detected from among these neighboring partial images as a result of the above determination or searching, calculation memory 1022 changes “X” thus detected into “E” (step SS003 in FIG. 24). In this manner, the determination or search about all the partial images of input image “B” is completed. Thereby, the feature values of the respective partial images of image “B” in FIG. 25C are updated to the values in FIG. 25D. Captured image feature value memory 1025 stores the updated values of the partial images.

The above changing or updating will now be described with reference to FIG. 25C. After starting the determination of the feature value from the partial image of “g1”, the feature value of “X” is first detected from the partial image of “g28”. The feature values of all the partial images neighboring to the partial image of “g28” are determined, and thereby it is determined that the neighboring partial images of “g29”, “g36” and “g37” have the feature value of “X”. According to the detection result, the feature values “X” of the partial images of “g28”, “g29”, “g36” and “g37” in calculation memory 1022 are updated (changed) to “E” as illustrated in FIG. 25D.

In this example, the partial region formed of at least two partial images that have the feature values of “X” and continue to each other in one of the longitudinal, lateral or oblique directions are determined as the comparison-untargeted image elements. However, the conditions of the determination are not restricted to the above. For example, the partial image itself having the feature value of “X” may be determined as the comparison-untargeted image element, and another kind of combination may be employed.

<Similarity Score Calculation and Comparison Determination>

In view of the result of the determination of comparison-untargeted images by element determining unit 1047, the maximum matching score position searching as well as the similarity score calculation based on the result of such determination (step T3 in FIG. 4) will now be described with reference to the flowchart of FIG. 22. Variable “n” indicates a total number of the partial images (partial regions) in image “A”. The maximum matching score position searching and the similarity score calculation are performed on the partial images of reference image “A” in FIG. 25A as well as image “B” in FIG. 25E from which the comparison-untargeted elements are eliminated.

When element determining unit 1047 completes the determination, control unit 108 provides the template matching start signal to maximum matching score position searching unit 105, and waits for reception of the template matching end signal.

When maximum matching score position searching unit 105 receives the template matching start signal, it starts the template matching processing in steps S001-S007. In step S001, variable “i” of a count is initialized to “1”. In step S002, the image of the partial region defined as partial image “Ri” in reference image “A” is set as the template to be used for the template matching.

In step S0025, maximum matching score position searching unit 105 searches for reference image feature value memory 1024 to read a feature value “CRi” of partial image “Ri” of the template.

In step S003, the processing is performed to search for the location where image “B” exhibits the highest matching score with respect to the template set in step S002, i.e., the location where the data matching in image “B” occurs with respect to the template to the highest extent. In this searching or determining processing, the following calculation is performed for the partial images of image “B” except for the partial images of the feature values of “E”.

It is assumed that Ri(x, y) represents the pixel density at coordinates (x, y) that are determined based on the upper left corner of rectangular partial image “Ri” used as the template. B(s, t) represents the pixel density at coordinates (s, t) that are determined based on the upper left corner of image “B”, partial image “Ri” has a width of “w” and a height of “h”, and each of the pixels in images “A” and “B” can take the maximum density of “V0”. In this case, matching score Ci(s, t) at coordinates (s, t) in image “B” is calculated based on the density difference of the pixels according to the following equation (1).

$$Ci ( s , t ) = {\sum }_{y = 1}^{h} {\sum }_{x = 1}^{w} ( V 0 - \vert Ri ( x , y ) - B ( s + x , t + y ) \vert ) \qquad ( 1 )$$

In image “B”, coordinates (s, t) are successively updated, and matching score C(s, t) at updated coordinates (s, t) is calculated upon every updating. In this example, the highest score of matching with respect to partial image “Ri” is exhibited at the position in image “B” corresponding to the maximum value among matching scores C(s, t) thus calculated, and the image of the partial image at this position in image “B” is handled as a partial image “Mi”. Matching score C(s, t) corresponding to this position is set as maximum matching score “Cimax”.

In step S004, memory 102 stores maximum matching score “Cimax” at a predetermined address. In step S005, a movement vector “Vi” is calculated according to the following equation (2), and memory 102 stores calculated movement vector “Vi” at a predetermined address.

As described above, image “B” is scanned based on partial image “Ri” corresponding to position “P” in image “A”. When partial region “Mi” in position “M” exhibiting the highest matching score with respect to partial image “Ri” is detected, a directional vector from position “P” to position “M” is referred to as movement vector “Vi”. Since a finger is placed on fingerprint read surface 201 of fingerprint sensor 100 in various manners, one of the images, e.g., image “B” seems to move with respect to the other image “A” (i.e., the reference), and movement vector “Vi” indicates such relative movement. Since movement vector “Vi” indicates the direction and the distance, movement vector “Vi” represents the positional relationship between partial image “Ri” of image “A” and partial image “Mi” of image “B” in a quantified manner.
Vi=(Vix, Viy)=(Mix−Rix, Miy−Riy) (2)

In the equation (2), variables “Rix” and “Riy” indicate the values of x- and y-coordinates of the reference position of partial image “Ri”, and correspond to the coordinates of the upper left corner of partial image “Ri” in image “A”. Variables “Mix” and “Miy” indicate the x- and y-coordinates of the position corresponding to maximum matching score “Cimax” that is calculated from the result of scanning of partial image “Mi”. For example, variables “Mix” and “Miy” correspond to the coordinates of the upper left corner of partial image “Mi” in the position where it matches image “B”.

In step S006, a comparison is made between values of count variable “i” and variable “n”. Based on the result of this comparison, it is determined whether the value of count variable “i” is smaller than the value of variable “n” or not. When the value of variable “i” is smaller than the value of variable “n”, the process proceeds to step S007. Otherwise, the process proceeds to step S008.

In step S007, one is added to the value of variable “i”. Thereafter, steps S002-S007 are repeated to perform the template matching while the value of variable “i” is smaller than the value of variable “n”. This template matching is performed for all partial images “Ri” of image “A”, and the targets of this template matching is restricted on the partial images of image “B” having a feature value “CM” of the same value as corresponding feature value “CRi” that is read by scanning reference image feature value memory 1024 for partial image “Ri” in question. Thereby, maximum matching score “Cimax” of each partial image “Ri” and movement vector “Vi” are calculated.

Maximum matching score position searching unit 105 stores, at the predetermined address in memory 102, maximum matching scores “Cimax” and movement vectors “Vi” that are successively calculated for all partial images “Ri” as described above, and then transmits the template matching end signal to control unit 108 to end the processing.

Then, control unit 108 transmits the similarity score calculation start signal to similarity score calculate unit 106, and waits for reception of the similarity score calculation end signal. Similarity score calculate unit 106 executes the processing in steps S008-S020 in FIG. 22 and thereby performs the similarity score calculation. For this processing, similarity score calculate unit 106 uses information such as movement vector “Vi” of each partial image “Ri” and maximum matching score “Cimax” that are obtained by the template matching and are stored in memory 102.

In step S008, the value of similarity score “P(A, B)” is initialized to 0. Similarity score “P(A, B)” is a variable indicating the similarity score obtained between images “A” and “B”. In step S009, the value of index “i” of movement vector “Vi” used as the reference is initialized to 1. In step S010, similarity score “Pi” relating to movement vector “Vi” used as the reference is initialized to 0. In step S011, index “j” of movement vector “Vj” is initialized to 1. In step S012, a vector difference “dVij” between reference movement vector “Vi” and movement vector “Vj” is calculated according to the following equation (3):
dVij=|Vi−Vj|=sqrt((Vix−Vjx)ˆ2+(Viy−Vjy)ˆ2) (3)
where variables “Vix” and “Viy” represent components in the x- and y-directions of movement vector “Vi”, respectively. Variables “Vjx” and Vjy” represent components in the x- and y-directions of movement vector “Vj”, respectively. A variable “sqrt(X)” represents a square root of “X”, and “Xˆ2” represents an equation for calculating the square of “X”.

In step S013, a value of vector difference “dVij” between movement vectors “Vi” and “Vj” is compared with a threshold indicated by a constant “ε”, and it is determined based on the result of this comparison whether movement vectors “Vi” and “Vj” can be deemed to be substantially the same movement vector or not. When the result of comparison indicates that the value of vector difference “dVij” is smaller than the threshold (vector difference) indicated by constant “ε”, it is determined that movement vectors “Vi” and “Vj” can be deemed to be substantially the same movement vector, and the process proceeds to step S014. When the value is equal to or larger than constant “ε”, it is determined that these vectors cannot be deemed as substantially the same vector, and the process proceeds to step S015. In step S014, the value of similarity score “Pi” is incremented according to the following equations (4)-(6).
Pi=Pi+α (4)
α=1 (5)
α=Cjmax (6)

In equation (4), variable “α” is a value for increasing similarity score “Pi”. When “α” is set to 1 (a=1) as represented by equation (5), similarity score “Pi” represents the number of partial regions that have the same movement vector as reference movement vector “Vi”. When “α” is set to Cjmax (a=Cjmax) as represented by equation (6), similarity score “Pi” represents the total sum of the maximum matching scores obtained in the template matching of partial areas that have the same movement vector as reference movement vector “Vi”. The value of variable “α” may decreased depending on the magnitude of vector difference “dVij”.

In step S015, it is determined whether the value of index “j” is smaller than the value of variable “n” or not. When it is determined that the value of index “j” is smaller than the total number of the partial regions indicated by variable “n”, the process proceeds to step S016. Otherwise, the process proceeds to step S017. In step S016, the value of index “j” is incremented by one. Through the processing in steps S010-S016, similarity score “Pi” is calculated using the information about the partial regions that are determined to have the same movement vector as movement vector “Vi” used as the reference. In step S017, movement vector “Vi” is used as the reference, and the value of similarity score “Pi” is compared with that of variable “P(A, B)”. When the value of similarity score “Pi” is larger than the maximum similarity score (value of variable “P(A, B)”) already obtained, the process proceeds to step S018. Otherwise, the process proceeds to step S019.

In step S018, variable “P(A, B)” is set to a value of similarity score “Pi” with respect to movement vector “Vi” used as the reference. In steps S017 and S018, when similarity score “Pi” obtained using movement vector “Vi” as the reference is larger than the maximum value (value of variable “P(A, B)”) of the similarity score among those already calculated using other movement vectors as the reference, movement vector “Vi” currently used as the reference is deemed as the most appropriate reference among indexes “i” already obtained.

In step S019, the value of index “i” of reference movement vector “Vi” is compared with the number (value of variable “n”) of the partial regions. When the value of index “i” is smaller than the number of the partial areas, the process proceeds to step S020, in which index “i” is incremented by one.

Through steps S008 to S0202, the score of similarity between images “A” and “B” is calculated as the value of variable “P(A, B)”. Similarity score calculate unit 106 stores the value of variable “P(A, B)” thus calculated at the predetermined address in memory 102, and transmits the similarity score calculation end signal to control unit 108 to end the processing.

Subsequently, control unit 108 transmits the comparison determination start signal to comparison determining unit 107, and waits for reception of the comparison determination end signal. Comparison determining unit 107 performs the comparison and determination (step T4). More specifically, it compares the similarity score indicated by the value of variable “P(A, B)” stored in memory 102 with a predetermined comparison threshold “T”. When the result of comparison indicates (variable P(A, B)≧T), comparison determining unit 107 determines that images “A” and “B” are obtained from the same fingerprint, and writes a value, e.g., of “1” indicating the matching as the comparison result at a predetermined address in memory 102. Otherwise, comparison determining unit 107 determines that images “A” and “B” are obtained from different fingerprints, respectively, and writes a value, e.g., of “0” indicating the mismatching as the comparison result at the predetermined address in calculation memory 1022. Thereafter, it transmits the comparison determination end signal to control unit 108 to end the processing.

Finally, control unit 108 outputs the comparison results stored in memory 102 via display 610 or printer 690 (step T4), and ends the image comparison.

In this embodiment, both images “A” and “B” are input through image input unit 101. However, the following configuration may be employed. Memory 102 includes a registered image storage for registering in advance a plurality of partial images “Ri” of image “A”, and comparison processing unit 11 reads partial image “Ri” of image “A” from the registered image storage. Image “B” is inputted through image input unit 101.

In this embodiment, all or a part of image correcting unit 104, feature value calculate unit 1045, element determining unit 1047, maximum matching score position searching unit 105, similarity score calculate unit 106, comparison determining unit 107 and control unit 108 may be implemented by a ROM such as memory 624 storing programs of the processing procedures and a processor such as CPU 622 for executing the programs.

### Effect of the Embodiment

A specific example of the comparison processing according to the embodiment as well as the effect thereof are as follows.

When input image “B” is a fingerprint image stained as indicated by a hatched circle in FIG. 25B, and is compared with reference image “A” shown in FIG. 25F as it is, the rate at which the 25 portions forming the image in FIG. 25B match reference image “A” in FIG. 25F is equal to (25−4)/25=0.84, where 4 corresponds to the four partial images in FIG. 25C determined to have partial image values of “X” due to the smear.

Assuming that the partial images of input image “B” must have the matching rate of 90% (0.9) or more with respect to reference image “A”, the comparison result would be “mismatching” if image “B” having the feature values in FIG. 25C were used for the comparison as it was.

However, element determining unit 1047 in the embodiment designates the stained potential regions as the comparison-untargeted image elements. Therefore, the comparison between images “B” and “A” is performed by comparing the comparison image in FIG. 25E in which the comparison-untargeted image elements are designated with reference image “A” in FIG. 25F. Therefore, the matching rate is equal to (25−4)/(25−4)=1, and the comparison result indicates “matching”.

As described above, the embodiment can eliminate the processing of checking the presence of smear on fingerprint read surface 201 of fingerprint sensor 100, and thus can eliminate the processing that is required before the fingerprint comparing processing in the prior art. Further, the smear is not detected directly from the image read through the whole fingerprint read surface 201, but is detected according to the information obtained in connection with the partial images determined to have the feature values of “X”. Therefore, the reference for calculating the feature value of “X” by feature value calculate unit 1045 can be variable according to the required rate of matching, and thereby the comparison processing can be continued without requiring cleaning by changing the reference when the position/size of the smear is practically ignorable. Consequently, the more images can be processed per unit time. Also, such a situation can be suppressed that the user is requested to input the fingerprint again due to the smear and/or to clean out the smear, and thus the inconvenience to the user can be prevented.

### Second Embodiment

The processing function for image comparison already described is achieved by programs. According to a second embodiment, such programs are stored on computer-readable recording medium.

In the second embodiment, the recording medium may be a memory required for processing by the computer show in FIG. 2 and, for example, may be a program medium itself such as memory 624. Also, the recording medium may be configured to be removably attached to an external storage device of the computer and to allow reading of the recorded program via the external storage device. The external storage device may be a magnetic tape device (not shown), FD drive 630 or CD-ROM drive 640. The recording medium may be a magnetic tape (not shown), FD 632 or CD-ROM 642. In any case, the program recorded on each recording medium may be configured such that CPU 622 accesses the program for execution, or may be configured as follows. The program is read from the recording medium, and is loaded onto a predetermined program storage area in FIG. 2 such as a program storage area of memory 624. The program thus loaded is read by CPU 622 for execution. The program for such loading is prestored in the computer.

The above recording medium can be separated from the computer body. A medium stationarily bearing the program may be used as such recording medium. More specifically, it is possible to employ tape mediums such as a magnetic tape and a cassette tape as well as disk mediums including magnetic disks such as FD 632 and fixed disk 626, and optical disks such as CD-ROM 642, MO (Magnetic Optical) disk, MD (Mini Disk) and DVD (Digital Versatile Disk), card mediums such as an IC card (including a memory card) and optical card, and semiconductor memories such as a mask ROM, EPROM (Erasable and Programmable ROM), EEPROM (Electrically EPROM) and flash ROM.

Since the computer in FIG. 2 has a structure which can establish communications over communications network 300 including the Internet. Therefore, the recording medium may be configured to bear flexibly a program downloaded over communications network 300. For downloading the program over communications network 300, a program for the download operation may be prestored in the computer itself, or may be preinstalled on the computer itself from another recording medium.

The contents stored on the recording medium are not restricted to the program, and may be data.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image comparing apparatus comprising:
an element detecting unit for detecting an element not to be used for comparison in an image;
a comparison processing unit for performing comparison using said image not including said element detected by said element detecting unit; and
a feature value detecting unit for detecting and providing a feature value according to a pattern of the partial image corresponding to each of the partial images in said image, wherein
said element detecting unit detects, as said element, a region indicated by a combination of said partial images having predetermined feature values provided from said feature value detecting unit.

2. The image comparing apparatus according to claim 1, wherein
said image is an image of a fingerprint, and
said feature value provided from said feature value detecting unit is classified as a value indicating that said pattern of said partial image extends in a vertical direction of said fingerprint, a value indicating that said pattern of said partial image extends in a horizontal direction of said fingerprint or a value indicating otherwise.

3. The image comparing apparatus according to claim 2, wherein
said predetermined feature value represents said value indicating otherwise.

4. The image comparing apparatus according to claim 3, wherein
said combination consists of a plurality of said partial images having said value indicating otherwise neighboring to each other in a predetermined direction in said image.

5. The image comparing apparatus according to claim 1, wherein
said image is an image of a fingerprint, and
said feature value provided from said feature value detecting unit is classified as a value indicating that said pattern of said partial image extends in an obliquely rightward direction of said fingerprint, a value indicating that said pattern of said partial image extends in an obliquely leftward direction of said fingerprint or a value indicating otherwise.

6. The image comparing apparatus according to claim 1, wherein
said comparison processing unit includes:
a position searching unit for searching a position of a region indicating a maximum score of matching with a partial region of a first image in the partial regions excluding a region of the element detected by said element detecting unit in a second image,
a similarity score calculating unit for calculating and providing a score of similarity between said first and second images based on a positional relationship quantity indicating a relationship between a reference position for measuring the position of the region in said first image and a position of the maximum matching score searched by said position searching unit, and
a determining unit for determining, based on a provided said similarity score, whether said first and second images match each other or not.

7. The image comparing apparatus according to claim 6, wherein
said position searching unit searches said maximum matching score position in each of said partial images in the partial regions of said second image excluding the region of the element detected by said element detecting unit, and
said similarity score calculating unit provides, as said similarity score, the number of said partial images exhibiting such a relationship that a quantity of said positional relationship between said maximum matching score position searched by said position searching unit and said reference position in said partial image of said second image is smaller than a predetermined quantity.

8. The image comparing apparatus according to claim 7, wherein
said positional relationship quantity indicates a direction and a distance of said maximum matching score position to said reference position.

9. The image comparing apparatus according to claim 6, wherein
said similarity score calculating unit calculates a sum of said maximum matching scores obtained from said partial images having said positional relationship quantity smaller than a predetermined quantity is provided as said similarity score.

10. The image comparing apparatus according to claim 6, further comprising:
an image input unit for inputting the image; and
a registered image storage for storing images of a plurality of the preregistered partial images, wherein
said partial images of said first image are read from said registered image storage, and the second image is input by said image input unit.

11. The image comparing apparatus according to claim 10, wherein
said image input unit has a read surface bearing a target for reading an image of said target placed on said read surface.

12. An image comparing method using a computer for comparing an image, and comprising includes the steps of:
detecting an element not to be used for comparison in the image;
performing comparison using said image not including said element detected by said step of the element detection; and
detecting and providing a feature value according to a pattern of a partial image corresponding to each of the partial images in said image, wherein
said step of detecting the element detects, as said element, a region indicated by a combination of said partial images having predetermined feature values provided from said step of calculating said feature value.

13. An image comparison program for causing a computer to execute the image comparison method according to claim 12.

14. A computer-readable record medium bearing an image comparison program for causing a computer to execute the image comparison method according to claim 12.
